(19) United States
(12) Patent Application Publication
(10) Pub. No.: US 2023/0134717 A1
(43) Pub. Date: May 4, 2023

(54) METHODS AND SYSTEMS FOR PROCESSING AND INTERPRETING ROADSIDE LiDAR DATA

(71) Applicant: Board of Regents of the Nevada System of Higher Education, on behalf of the University of Nevada, Reno, NV (US)

(72) Inventor: Hao Xu, Reno, NV (US)

(21) Appl. No.: 17/980,103

(22) Filed: Nov. 3, 2022

Related U.S. Application Data
(60) Provisional application No. 63/263,518, filed on Nov. 4, 2021.

(51) Int. Cl. G08G 1/01

(52) U.S. Cl. CPC G08G 1/0133; G08G 1/0116; G08G 1/0145

(57) ABSTRACT

Methods, systems and apparatus are disclosed for conducting background filtering on LiDAR sensor data. In some embodiments, a computer processor of a computer receives raw LiDAR sensor data from a roadside LiDAR sensor, decodes the raw LiDAR sensor data into 3D distance data, azimuth angle data and vertical angle data, and then generates a background table of datapoints utilizing the azimuth angle data and elevation data. The process also includes the computer processor comparing the 3D distance data to the datapoints of the background table, determining, based on the comparisons, static background object datapoints, and discarding the static background object datapoints. In implementations, the computer processor determines target datapoints based on the comparisons, and then stores the target datapoints in a storage device.

### CROSS REFERENCE TO RELATED APPLICATIONS

This patent application claims the benefit of U.S. Provisional Patent Application No. 63/263,518 filed on Nov. 4, 2021, the contents of which are hereby incorporated by reference for all purposes.

### BACKGROUND

Light Detection and Ranging (LiDAR) is a method for determining ranges (variable distance) by targeting an object with a laser and then measuring the time for the reflected light to return to a receiver. LiDAR has been utilized for many different types of applications such as making digital 3-D representations of areas on the earth's surface and ocean bottom.

LiDAR sensors have also been used in the intelligent transportation field because of their powerful detection and localization capabilities. In a particular application, LiDAR sensors have been installed on autonomous vehicles (or self-driving vehicles) and used in conjunction with other sensors, such as digital video cameras and radar devices, to enable the autonomous vehicle to safely navigate along roads. It has recently been recognized that LiDAR sensors could potentially be deployed as part of the roadside infrastructure, for example, incorporated into a traffic light system at intersections as a detection and data generating apparatus. The detected traffic data can then be used by connected vehicles (CVs) and by other infrastructure systems to aid in preventing collisions and to protect non-motorized road users, to evaluate the performance of autonomous vehicles, and for the general purpose of collecting traffic data for analysis. For example, roadside LiDAR sensor data at a traffic light can be used to identify when and where vehicle speeding is occurring, and it can provide a time-space diagram which shows how vehicles slow down, stop, speed up and go through the intersection during a light cycle. In addition, roadside LiDAR sensor data can be utilized to identify “near-crashes,” where vehicles come close to hitting one another (or close to colliding with a pedestrian or bicyclist), and thus identify intersections or stretches of roads that are potentially quite dangerous.

Connected-Vehicle (CV) technology is an emerging technology that aims to reduce vehicle collisions and provide energy efficient transportation for people. CV technology allows bi-directional communications between roadside infrastructure and the connected vehicles (road users) for sharing real-time traffic and/or road information and provide rapid responses to potential events and/or to provide operational enhancements. However, some currently deployed CV systems suffer from an information gap concerning information or data about unconnected vehicles, pedestrians, bicycles, wild animals and/or other hazards.

Roadside LiDAR sensor systems can potentially be utilized to close the information gap that typical CV systems suffer from. In particular, roadside LiDAR systems can be incorporated into the roadside infrastructure to generate data concerning the real-time status of unconnected road users within a detection range to thus provide complementary traffic and/or hazard information or data. For example, LiDAR sensor systems can be utilized to detect one or more vehicles that is/are running a red light and/or pedestrians who are crossing against a red light and share that information with any connected road users.

A common misconception is that the application of roadside LiDAR sensors is similar to the application of on-board vehicle LiDAR sensors, and that therefore the same processing procedures and algorithms utilized by on-board LiDAR systems could be applicable to roadside LiDAR systems (possibly with minor modifications). However, on-board LiDAR sensors mainly focus on the surroundings of the vehicle and the goal is to directly extract objects of interest from a constantly changing background. In contrast, roadside LiDAR sensors must detect and track all road users in a traffic scene against a static background. Thus, infrastructure-based, or roadside LiDAR sensing systems have the capability to provide behavior-level multimodal trajectory data of all traffic users, such as presence, location, speed, and direction data of all road users from raw roadside LiDAR sensor data. In addition, low cost sensors may be used to gather such real-time, all-traffic trajectories for extended distances, which can provide critical information for connected and autonomous vehicles so that an autonomous vehicle traveling into the area covered by a roadside LiDAR sensor system becomes aware of potential upcoming collision risks and the movement status of other road users while still at a distance away from the area or zone. Thus, the tasks of obtaining and processing trajectory data are different for a roadside LiDAR sensor system than for an on-board vehicle LiDAR sensor system.

Accordingly, for infrastructure-based or roadside LiDAR sensor systems, it is important to detect target objects in the environment quickly and efficiently because fast detection speeds provide the time needed for making a post-detected response, for example, by an autonomous vehicle to avoid a collision with other road users in the real-world. Detection accuracy is also a critical factor to ensure the reliability of a roadside LiDAR based system. Thus, roadside LiDAR sensor systems are required to exclude the static background points and finely partition those foreground points as different entities (clusters).

In addition to supporting connected and autonomous vehicles, the all-traffic trajectory data generated by a roadside LiDAR system may be valuable for traffic study and performance evaluation, advanced traffic operations, and the like. For example, analysis of lane-based vehicle volume data can achieve an accuracy above 95%, and if there is no infrastructure occlusion, the accuracy of road volume detection can generally be above 98% for roadside LiDAR systems. Other applications for collected trajectory data include providing conflict data resources for near-crash analysis, including collecting near-crash data (especially vehicle-to-pedestrian near-crash incidents) that occur during low-light level situations such as during rainstorms and/or during the night hours when it is dark. In this regard, roadside LiDAR sensors deployed at fixed locations (e.g., road intersections and along road medians) provide a good way to record trajectories of all road users over the long term, regardless of illumination conditions. Traffic engineers can then study the historical trajectory data provided by the roadside LiDAR system at multiple scales to define and extract near-crash events, identify traffic safety issues, and recommend countermeasures.

Regarding traffic performance measurements using trajectory data, one challenge is how to classify all of the different types of road users as accurately as possible, even if they are far away from the LiDAR traffic sensors. In general, large-sized road users (e.g., vehicles such as cars, buses and trucks) are relatively easy to identify as compared to smaller-sized road users (e.g., pedestrians, bicyclists and wheelchair users) because the direction of movement and the appearance of small-sized road users constantly changes. In addition, road users who are located near the LiDAR sensor(s) and/or other sensors and are not occluded by other objects are more likely to be classified into a category correctly because such collected data or information is more comprehensive and reliable.

In a classic vehicle on-board LiDAR-Vision sensing system, two sensors work together in a centralized or in a decentralized manner to generate data that can be used to achieve somewhat satisfactory object classification. Centralized processing means that a sensor fusion process occurs at the feature level, wherein features extracted from the LiDAR data and the video data are combined into a single vector for classification using a single classifier. Decentralized processing occurs when two classifiers are trained with LiDAR data and video data individually, and then the final classification results are combined through a set of fusion methods. For example, convolutional neural network (CNN) and image up-sampling methods may be used to generate LiDAR-Vision fusion data that achieves a classification accuracy of about 100% for pedestrians and cyclists, about 98.6% for cars, and about 88.6% for trucks.

Weaknesses inherent in the use of existing on-board LiDAR classifiers include a short effective detection range and no vision data supporting the classification. The inventors have recognized that there is a need for providing improved classification methods and systems for accurately classifying pedestrians, wheelchair users, vehicles and cyclists using roadside LiDAR sensor systems.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1A depicts a permanent LiDAR sensor system installation located at an intersection of roadways in accordance with some embodiments of the disclosure;

FIG. 1B illustrates another embodiment of a roadside LiDAR sensor system situated alongside a road, or alongside a road segment, in accordance with embodiments of the disclosure;

FIG. 1C illustrates a portable roadside LiDAR sensor system located along a road segment in accordance with some embodiments of the disclosure;

FIG. 1D illustrates another embodiment of a portable roadside LiDAR sensor system which may be located along a road segment in accordance with some embodiments of the disclosure;

FIG. 2 is a functional diagram 200 illustrating the components of a portable roadside LiDAR sensor system in accordance with some embodiments

FIG. 3 is a functional diagram 300 illustrating the components of a permanent roadside LiDAR sensor system embodiment in accordance with the disclosure.

FIG. 4A is a graph illustrating an example distribution, without any occlusion, of measured distance values by a LiDAR sensor of a building corner varied within a very small interval in accordance with some embodiments of the disclosure;

FIG. 4B is a graph illustrating measured distribution values by a LiDAR sensor when the building edge was blocked by passing vehicles and a stopped vehicle, resulting in obtaining a smaller amount of distance values due to these occlusions in accordance with some embodiments of the disclosure;

FIGS. 5A and 5B illustrate, respectively, a graph of the measured distance values of dense trees and the measured distance values of sparse bushes by a LiDAR sensor in accordance with some embodiments of the disclosure;

FIG. 6 depicts a diagram illustrating how a LiDAR sensor determines target datapoints in accordance with aspects of the disclosure;

FIG. 7A is a flowchart illustrating a background filtering process in accordance with some embodiments of the disclosure;

FIG. 7B is a flowchart illustrating a method for generating a final background datapoint table according to some embodiments of the disclosure;

FIG. 8 is a functional block diagram comparing methods for processing raw LiDAR sensor data via a two-dimensional (2D) and a three-dimensional (3D) data structure in accordance with some embodiments of the disclosure;

FIG. 9A is a graphical representation of a test example, before background filtering, of a total of 57,888 raw datapoints which included 5,644 target points (14 vehicles) and 52,244 background points (buildings, ground surfaces, trees, etc.);

FIG. 9B is a graphical representation of the test example of FIG. 9A after background filtering using methods in accordance with some embodiments of the disclosure;

FIG. 10 illustrates an azimuth and a zenith block diagram illustrating how data is obtained by a LiDAR sensor according to some embodiments of the disclosure;

FIG. 11 illustrates a spherical map which is a two-dimensional (2D) map whose rows and columns represent the azimuth discretization and zenith channels, respectively;

FIG. 12 is a spherical map representation of a point arrangement of a vehicle (marked by a dotted circle) in both a spherical map space and a 3D space in accordance with some embodiments of the disclosure;

FIG. 13 depicts a comparison of a neighborhood searching approach between the DBSCAN process and a FSCTD process according to some embodiments of the disclosure;

FIG. 14 is a graph depicting two objects at two different positions to illustrate a point density variation problem;

FIG. 15 illustrates the difference of DBSCAN and FSCTD in considering spatial distances between point A and point B in accordance with some embodiments of the disclosure;

FIG. 16 depicts a point-cloud visualization utilizing a special clustering two-dimensional method before filtering and then after filtering in accordance with some embodiments of the disclosure;

FIG. 17 depicts graphs presenting the average score of metrics given different minimum sample points to establish a core point (minPts) settings of target points and dynamic background points according to some embodiments of the disclosure;

FIG. 18 depicts graphs illustrating the average metrics given different Eps values in accordance with some embodiments of the disclosure;

FIGS. 19 and 20 illustrate graphs depicting plots of the tested window widths and window heights, respectively, of target points and dynamic window points in accordance with some embodiments of the disclosure;

FIG. 21 depicts a graph showing time consumption variation of the window width and the window height in accordance with some embodiments of the disclosure;

FIG. 22 is a three-dimensional (3D) visualization illustrating the improvement of the disclosed FSCTD process over using the DBSCAN process;

FIG. 23 includes two visualizations comparing the detection range of the same intersection using the DBSCAN process and using the FSCTD process in accordance with some embodiments of the disclosure;

FIG. 24 is a chart illustrating an example of the impact of foreground data points accumulated across 18,000 frames in an intersection on algorithm efficiency;

FIG. 25 depicts graphs illustrating the correlation between the foreground points and the time efficiency of clustering in accordance with some embodiments of the disclosure;

FIG. 26 is a graph illustrating output of the FSCTD process showing a plot of the foreground points versus time consumption, wherein the maximum time consumption does not exceed 85 ms for a number of foreground points over 20,000, in accordance with some embodiments of the disclosure;

FIG. 27 depicts visualizations of four different road user classifications including a vehicle, pedestrian, cyclist and wheelchair in accordance with some embodiments of the disclosure;

FIG. 28 is a flowchart of a roadside LiDAR sensor data processing process in accordance with some embodiments of the disclosure;

FIG. 29 is a visualization of geo-located trajectories extracted from one half-hours' worth of data collected by a portable LiDAR sensor located at an intersection;

FIG. 30 illustrates to and side view visualizations of features extracted from clusters in accordance with embodiments of the disclosure;

FIG. 31 is graph plotting the point count versus distance distributions of the four types of road users of FIG. 27 according to some embodiments of the disclosure;

FIG. 32 is graph plotting the point distribution direction versus distance distributions of the four types of road users of FIG. 27 according to some embodiments of the disclosure;

FIG. 33 is graph plotting the detected length of an object versus distance distributions of the four types of road users of FIG. 27 according to some embodiments of the disclosure;

FIG. 34 is a graph showing the feature significance ranking of the RUSBoost classifier, wherein Length>Area>Distance>Direction>Height>Height variance>Point count, illustrating that 2D length is a significant feature for classifying vehicles, pedestrians, cyclists and wheelchairs in accordance with some embodiments of the disclosure;

FIG. 35 is a graphical representation of the distance and length of pedestrian features in accordance with some embodiments of the disclosure;

FIG. 36 is a graphical representation of distance and length of cyclist features in accordance with some embodiments of the disclosure;

FIG. 37 is a graphical representation of distance and length of wheelchair features in accordance with some embodiments of the disclosure;

FIG. 38 is a chart of the detected length of an object as a function of the distance away from a LiDAR sensor in accordance with some embodiments of the disclosure;

FIG. 39 is a visualization illustrating how one object can be misclassified as wrong object types; and

FIG. 40 is a block diagram of a traffic data processing computer according to some embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of the embodiments may be practiced without some or all of the specific details. In other instances, well-known process operations have not been described in detail in order not to unnecessarily obscure novel aspects. In addition, terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used.

As used herein, the term “module” refers broadly to software, hardware, or firmware (or any combination thereof) components. Modules are typically functional components that can generate useful data or other output using specified input(s). A module may or may not be self-contained. An application program (sometimes called an “application” or an “app” or “App”) may include one or more modules, or a module can include one or more application programs.

In general, and for the purposes of introducing concepts of embodiments of the present disclosure, disclosed herein are roadside LiDAR systems and methods for processing, analyzing, and using traffic data to create a human-in-the-loop system in which all road users, especially pedestrians and cyclists, will be actively protected. Some embodiments focus on computational efficiency because roadside LiDAR applications must quickly and accurately perform complete background filtering and monitor real-time traffic movements. Thus, in some embodiments methods are disclosed for fast background filtering of roadside LiDAR data that embed background filtering within the decoding process to exclude irrelevant information, thus avoiding unnecessary calculation of those datapoint coordinates (as well as avoiding performing further segmentation and/or clustering and classification processing). Specifically, an improved method is disclosed that translates the location of 3D LiDAR datapoints into a 2D structure based on channel, azimuth, and distance information.

In another aspect, disclosed is a fast clustering method that is based on generating a two-dimensional (2D) map. Datapoint cloud clustering is an important component for processing roadside LiDAR traffic data, and clustering processing has a profound effect on the accuracy and efficiency of object detection which impacts the effectiveness of roadside LiDAR applications such as LiDAR based connected-vehicle systems. In some disclosed embodiments, a fast clustering process is based on a spherical projection map wherein the process provides improved detection accuracy and lower computational complexity as compared to conventional methods. The fast clustering method also enables a wider detection range and provides improved robustness. Reasons for the improvement include the adoption of a 2D searching window and the use of a spherical map which greatly improves processing speed for performing a neighborhood query in the clustering process and provides less sensitivity to the varying point density. In some implementations, the Fast Spatial Clustering based on Two-dimensional Map (FSCTD) process is implemented using the Python coding language.

In yet another aspect associated with processing roadside LiDAR sensor data, disclosed is a high-accuracy, feature-based road user classification process. The high-accuracy process utilizes prior trajectory information to classify vehicles, pedestrians, cyclists and wheelchairs. By updating significant features based on prior information of the entire trajectory, more critical features were used as the input of classifiers to increase classification accuracy. In an implementation, the process includes updating critical features based on prior trajectory information, which greatly improves the accuracy of classification, especially for classes having a small number of observations.

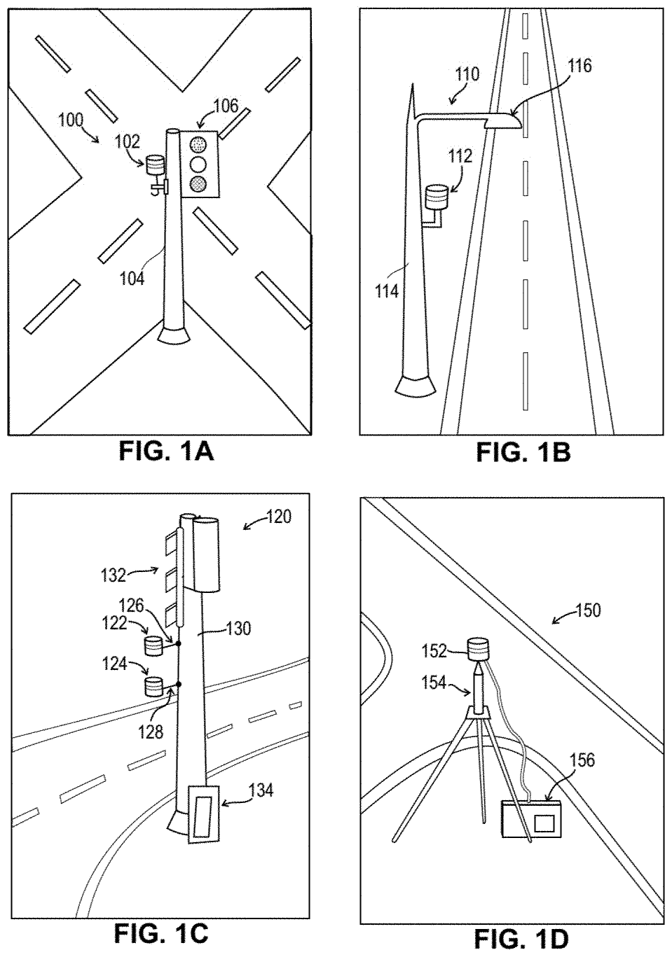

FIGS. 1A to 1D depict several different types of roadside LiDAR sensor system deployments in accordance with embodiments of the disclosure. LiDAR sensors use a wide array of infra-red lasers paired with infra-red detectors to measure distances to objects, and there are several companies that manufacture LiDAR sensor products, such as the Velodyne® Company of San Jose, Calif. The LiDAR sensors are usually securely mounted within a compact, weather-resistant housing and include an array of laser/detector pairs that spin rapidly within the fixed housing to scan the surrounding environment and provide a rich set of three-dimensional (3D) point data in real time. The lasers themselves are commonly used in other applications, for example in barcode scanners in grocery stores and for light shows and are eye-safe (will not damage human eyes). The selection of a particular type of LiDAR sensor to utilize depends on the purpose or application, and thus factors that may be considered include the number of channels (resolution of LiDAR scanning), the vertical field of view (FOV), and the vertical resolution of laser beams. A LiDAR sensor may have anywhere from eight (8) to one-hundred and twenty-eight (128) laser beams that are rotated 360 degrees to measure the surrounding environment in real-time. In general, LiDAR sensors with more laser channels, larger vertical FOV, and higher resolution are more productive in data collection.

FIG. 1A depicts a permanent LiDAR sensor system installation 100 located at an intersection of roadways. As shown, the LiDAR sensor 102 is affixed to a traffic light pole 104 that includes a traffic light 106. In some implementations, raw sensor data generated by the roadside LiDAR sensor 102 may be transmitted via a wired or wireless connection (not shown), for example, to an edge computer (not shown) and/or to a datacenter that includes one or more server computers (not shown) for processing.

FIG. 1B illustrates another embodiment of a roadside LiDAR sensor system 110 situated alongside a road, or alongside a road segment, in accordance with the disclosure. The LiDAR sensor 112 is attached to a lamppost 114 that includes a streetlamp 116. Like the LiDAR sensor system 100 of FIG. 1A, in some embodiments the sensor data generated by the roadside LiDAR sensor 112 may be transmitted via a wired or wireless connection (not shown), for example, to an edge computer (not shown) and/or to a datacenter that includes one or more server computers (not shown) for processing.

FIG. 1C illustrates a portable roadside LiDAR sensor system 120 located along a road segment in accordance with some embodiments. In this implementation, a first LiDAR sensor 122 and a second LiDAR sensor 124 may be removably affixed via connecting arms 126 and 128, respectively, to a traffic light post 130 below a traffic light 132 (or traffic signal head) as shown so as to be reachable for portable system installation and removal. The LiDAR sensor system 120 includes a portable sensor data processing unit 134 containing electronic circuitry (not shown) which may process the data generated by both the roadside LiDAR sensors 122 and 124 on-site and/or may transmit the sensor data and/or the processed data to a datacenter that includes one or more server computers (not shown), which may utilize the sensor data for further processing. The roadside LiDAR sensors assembly (sensors 122, 124 along with the connecting arms 126,128 and data processing unit 134) may be left in place to gather traffic related data for days, weeks or months.

FIG. 1D illustrates another embodiment of a portable roadside LiDAR sensor system 150 which may be located along a road segment in accordance with some embodiments. In this implementation, a first LiDAR sensor 152 is supported by a tripod 154 that is placed alongside a road or, for example, in a road median (not shown). The LiDAR sensor system 150 may also include a portable sensor data processing unit 156 which may store and/or process sensor data generated by the roadside LiDAR sensor 152. In some implementations, the LiDAR sensor system 150 is a standalone unit which is left on-site for only short periods of time, such as for a few hours, and then transported to a datacenter or otherwise operably connected to a host computer for processing and/or analyzing the traffic data captured by the roadside LiDAR sensor 152.

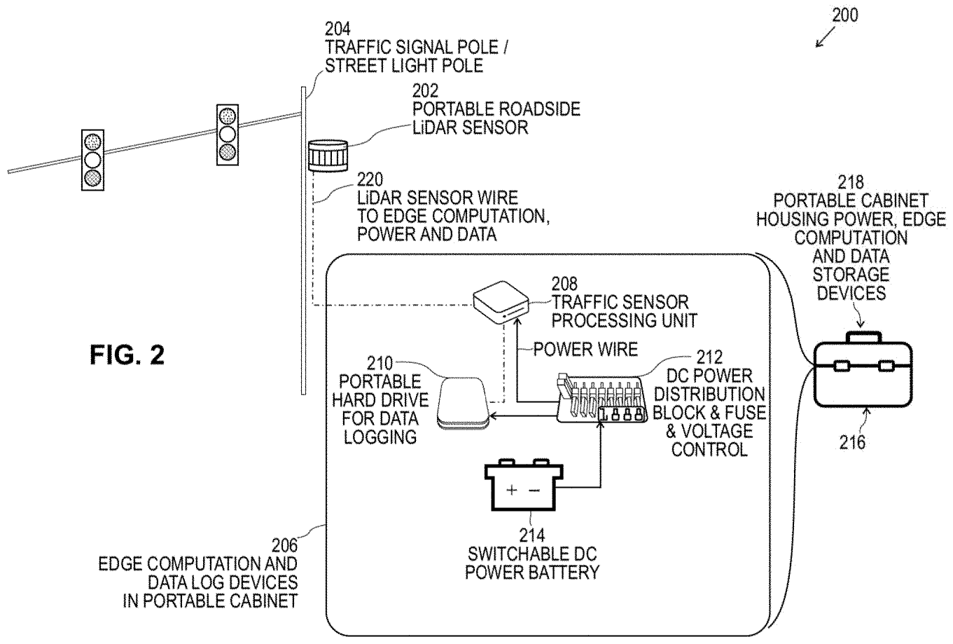

FIG. 2 is a functional diagram 200 illustrating the components of a portable roadside LiDAR sensor system in accordance with some embodiments. A portable roadside LiDAR sensor 202 is affixed to a traffic signal pole 204 (which may also be a streetlight pole). Edge processing circuitry 206 may include a traffic sensor processing unit 208 (or traffic sensor CPU), a portable hard drive 210, power control circuitry 212 and a battery 214 all housed within a hard-shell case 216 having a handle 218. The traffic sensor processing unit or CPU 208 may be a computer or several computers or a plurality of server computers that work together as part of a system to facilitate processing of roadside LiDAR sensor data. In such a system, different portions of the overall processing of such roadside LiDAR sensor data may be provided by one or more computers in communication with one or more other computers such that an appropriate scaling up of computer availability may be provided if and/or when greater workloads, for example if a large amount of roadside traffic data is generated and requires processing.

Referring again to FIG. 2, a wired or wireless connection 220 may electronically connect the roadside LiDAR sensor 202 to the edge processing circuitry. In some implementations, the traffic sensor processing unit 208 receives raw traffic data from the roadside LiDAR sensor 202, processes it and stores the processed data in the portable hard drive 210. The power control circuitry 212 is operably connected to the battery 214 and provides power to both the traffic sensor processing unit 208 and the portable hard drive 210. In some implementations, the edge processing circuitry 206 may be physically disconnected from the roadside LiDAR sensor 202 so that the hard-shell case 216 can be transported to a datacenter (not shown) or otherwise operably connected to a host or server computer (not shown) for processing and/or analyzing the traffic data captured by the roadside LiDAR sensor 202.

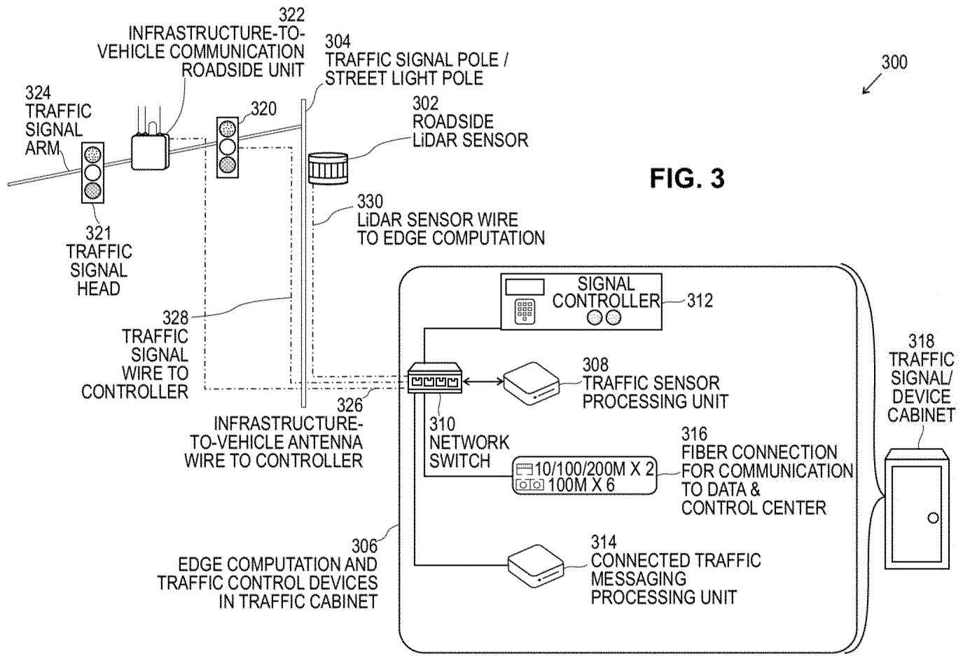

FIG. 3 is a functional diagram 300 illustrating the components of a permanent roadside LiDAR sensor system embodiment in accordance with the disclosure. A roadside LiDAR sensor 302 is affixed to a traffic signal pole 304 (which may also be a streetlight pole) and is operably connected to edge processing circuitry 306 which may be housed within a roadside traffic signal device cabinet 318. In some embodiments the roadside traffic signal device cabinet is locked and hardened to safeguard the electronic components housed therein against vandalism and/or theft.

Referring again to FIG. 3, in some embodiments the edge processing circuitry 306 includes a network switch 310 that is operably connected to a traffic sensor processing unit 308 (or traffic sensor CPU), to a signal controller 312, to a connected traffic messaging processing unit 314, and to a fiber-optic connector 316 (and in some embodiments to a fiber-optic cable, not shown). In some implementations, in addition to being operably connected to the roadside LiDAR sensor 302, the network switch 310 is also operably connected to the traffic light 320 and to a transmitter 322, which transmitter is operable to function as an infrastructure-to-vehicle roadside communication device. In the illustrated embodiment, the traffic lights 320 and 321, and the transmitter 322, are affixed to a traffic signal arm 324 that is typically positioned so that these devices are arranged over a roadway, typically over an intersection of roadways. In some implementations, the transmitter 322, the traffic light 320, and the roadside LiDAR sensor 302 are electrically connected to the network switch 310 via wires or cables 326, 328 and 330, respectively. In other implementations, these devices may instead be wirelessly connected to the network switch 310. In some embodiments, the traffic sensor processing unit 308 receives raw traffic data from the roadside LiDAR sensor 302, processes it and operates with the connected traffic messaging processing unit 314 and transmitter 322 to transmit data and/or instructions to a connected vehicle (CV) which may be traveling on the road and approaching the intersection. In addition, the traffic sensor processing unit 308 may transmit data via the fiberoptic connector 316 to a remote data and control center (not shown) for further processing and/or analysis.

The roadside LiDAR sensing systems described above with reference to FIGS. 1A through 1D, FIG. 2 and FIG. 3 may provide behavior-level, multimodal trajectory data of all traffic users, including but not limited to cars, buses, trucks, motorcycles, bicycles, wheelchair users, pedestrians and wildlife. Such real-time, all-traffic trajectories data can be gathered for extended distances and this critical information may be transmitted in real-time to connected and/or autonomous vehicles. Such operation permits such autonomous vehicles traveling into the area covered by the roadside LiDAR sensor system to be aware of potential upcoming collision risks and to be aware of the movement status of other road users while still being at a distance away from the area.

### I. LiDAR Sensor Data Background Filtering Methods

1. Background Filtering

As mentioned earlier, background filtering is a crucial element to consider when processing roadside LiDAR sensor data. This is because, according to data collected from testbeds, only about five percent (5%) to ten percent (10%) of the raw LiDAR sensor data are target points of interest. Thus, methods disclosed herein advantageously provide a fast and accurate background filtering process to remove datapoints that are not of interest which at the same time increases the overall processing speed and minimizes storage requirements. Since the background objects detected by infrastructure-based LiDAR sensors are fixed, the goal of background filtering for roadside LiDAR sensing systems is to classify raw datapoints into background datapoints (to discard) and target datapoints (to save).

LiDAR sensors use a wide array of infra-red lasers paired with infra-red detectors to measure distances to objects, and these LiDAR sensors are typically housed within a compact, weather-resistant housing. The array of laser/detector pairs spins rapidly within its fixed housing to scan the surrounding environment (a 360-degree horizontal field of view) and to provide a rich set of 3D point data in real time. Factors that are used to select which LiDAR sensor to use for any particular application include the number of channels, the vertical field of view (FOV), and the vertical resolution of the laser beams. In general, sensors with more laser channels, a larger vertical FOV, and a higher vertical resolution are more productive in data collection.

During use, one data frame is generated after the LiDAR sensors complete a three-hundred and sixty-degree (360°) scan. The collected point cloud is stored in a packet capture (.pcap) file and the size of the packet is determined by the number of laser channels, the time of data collection and the number and complexity of the surrounding objects. There are two steps for decoding “pcap” files to get three-dimensional (3D) LiDAR points. The first step includes obtaining azimuth (α), elevation angle (ω), 3D distance (R) between the object and the LiDAR sensor, timestamp data and intensity information, wherein azimuth is defined as a horizontal angle measured clockwise from any fixed reference plane or easily established base direction line. The second step is to convert the spherical coordinates to Cartesian coordinates. In other words, the azimuth, elevation angle, and the 3D distance of each data point in the spherical coordinate system can be firstly obtained from decoding the original LiDAR data file, while information such as the 3D location of each point in the Cartesian coordinate systems needs further calculation for conversion.

LiDAR sensor data can be represented as a point cloud. A data point's (X, Y, Z) Cartesian coordinates and (R, ω, α) spherical coordinates represent the same location of a data point. The 3D Cartesian coordinates of LiDAR sensor data are usually described by a 3D matrix, in which each dimension records the coordinates of the data points along one direction.

The locations that comprise the 3D point cloud can be described by a two-dimensional (2D) matrix/table structure based on the inherent properties of the LiDAR sensors, in which each row of the table indicates each elevation angle/channel of the laser beams; each column of the table represents each azimuth interval of the laser beams during a 0° to 360° scan, and the content of the table is the range value (i.e., the 3D distance between the LiDAR sensor and the data point collected from an object surface). In this manner, the range values of the data points which were measured by the same laser beam at the same azimuth interval are recorded in the same cell of the 2D table.

Given a LiDAR sensor with N laser beams, with a rotation frequency off Hz (i.e., f revolution per second), and wherein the firing time is t second per firing cycle, the horizontal azimuth resolution (ΔAzimuth) of laser beams can be calculated by:

ΔAzimuth=f(rotation/sec)×360(degree/rotation)×t(second/firing cycle)

The sized of the 2D table is N×M where the number of columns M is equal to 360 degrees divided by ΔAzimuth.

For roadside applications, there is no need to spend processing time and use memory space to calculate and save the Cartesian coordinates of the background objects because the large numbers of points will be deleted after the background filtering process. To address this issue, a decoding-based approach classifies the background points and the target (non-background) points based on the initially obtained channel, azimuth, and range information during the decoding process, and then only the target points are saved for future use.

For roadside applications, background objects can be classified into two categories. The first category includes static background objects such as buildings and ground surfaces, while the second category includes dynamic background objects such as waving bushes and trees. How to accurately capture the locations of background objects is crucial to the quality of background filtering.

With regard to the LiDAR sensor system's working mechanism, there is no guarantee that the laser beams will always shoot out at the exact same location during each rotation of the sensor arrays, and in some cases some laser beams may not return. Therefore, the number of data points collected in each 360° scan is usually not exactly the same every time. Considering the impact of random factors, continuous raw LiDAR data frames were aggregated to find more accurate locations of static background objects. Using the 2D data structure, the range values of all objects from each data frame were aggregated cell by cell to form a new 2D matrix of the same size.

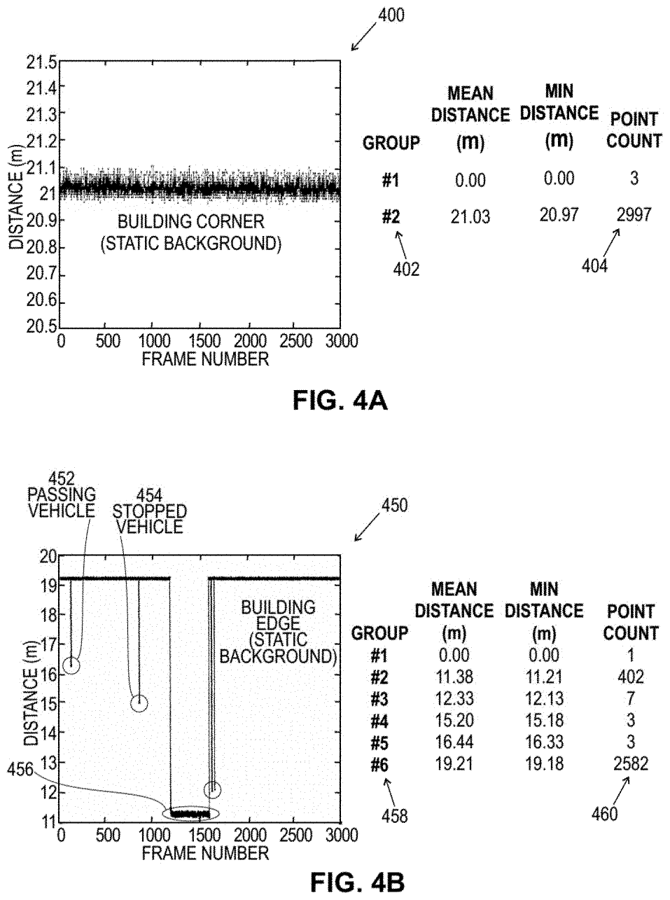

FIGS. 4A and 4B illustrate distributions 400 and 450, respectively, of the collected distance values of a building from two representative cells. In FIG. 4A, without any occlusion, the measured distance values of a building corner were varied within a very small interval (between 21.0 m and 21.1 m, having about a 10 cm variation), while in FIG. 4B, the building edge was blocked by passing vehicles 452, 454 and a stopped vehicle 456 for a while, and smaller distance values were obtained because of these occlusions.

To determine whether data are from static or dynamic objects, all data points in each table cell are segmented into different groups according to the one-dimensional clustering of aggregated distance values. In this manner, the mean distance, minimal distance, and point count information of each group can be obtained. Then, based on the mean distance, the groups in each table cell were sorted in ascending orders. If the count value of the last group (i.e., the farthest group from the sensor) is greater than a point threshold, then this group of data points was considered to have been measured from static background objects. In other words, the static background is identified by the farthest cluster that meets the point requirement. For example, the identified static backgrounds in FIGS. 4A and 4B were the building corner, designated as Group #2 402, which has 2,997 datapoints 404, and the building edge, designated as Group #6458 having 2,582 datapoints 460 when 3,000 frames were aggregated.

2. Identification of Dynamic Background in 3D Point Cloud Space

After excluding static background objects from the selected data frames of aggregation, the remaining data are composed of target objects, dynamic background objects, and some noise points. As dynamic background objects often change in slight motion but in a random fashion, the variation of measured distance is much larger than that of static background objects, which presents the challenge for filtering. A common method for filtering dynamic backgrounds is to use a simple frequency threshold, which usually leaves dynamic background points in the filtered data.

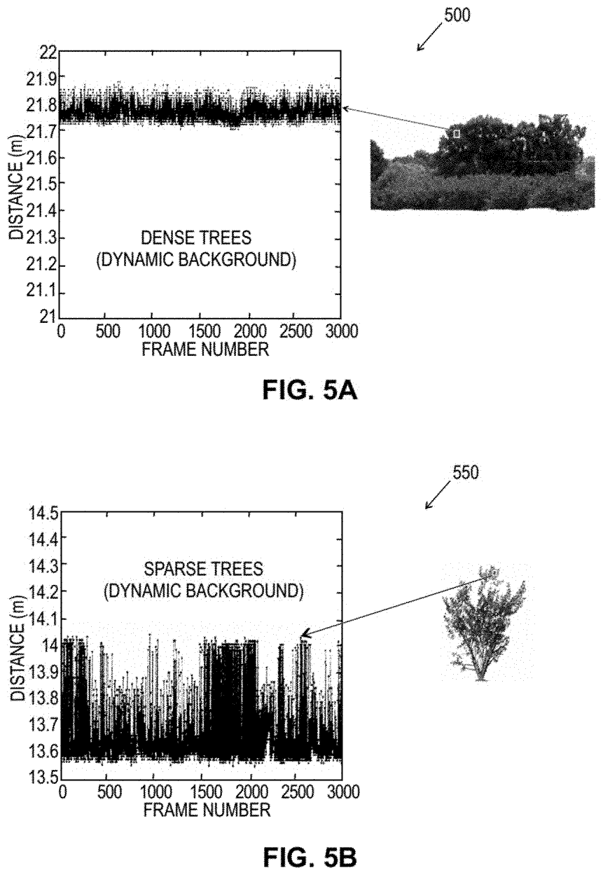

FIGS. 5A and FIG. 5B show the measured distances of dense trees 500 and sparse bushes 550 from a LiDAR sensor, respectively. FIG. 5B shows that the measured distances from the same part of a sparse bush may vary up to nearly 0.4 meters in the case of heavy winds. To accurately identify dynamic background objects, valid features in 3D space should be sought because finding effective features in a 2D structure is rather difficult. In an implementation, density-based spatial clustering of applications with noise (DBSCAN) process is applied to the same set of aggregated continuous LiDAR data frames in which static background points have been excluded. Then, based on the distribution characteristics of the data points, three features were extracted from the obtained clusters to distinguish dynamic background objects and target objects using Extra Trees (Extremely Randomized Trees) classifiers. The three extracted features were:

Feature 1: the maximal height of the entire cluster.

In general, the heights of dynamic background objects and target objects are different. For example, a vehicle or a pedestrian is higher than bushes, but lower than trees.

Feature 2: the maximal length of the entire cluster along the X- or Y-axis.

Since the target objects are moving, the obtained target object clusters are formed along the object's moving direction over time. For dynamic background objects, although it may be waving, the location will not change.

Feature 3: the standard deviation of the maximal height of each sliced cluster.

Cut the cluster along X- or Y-axis based on the Feature 2 to obtain sliced clusters. The maximal height in vehicle clusters will not change dramatically, while background cluster (such as trees) may have quite different heights.

Representation of Static and Dynamic Background in 2D Data Structure

After identifying the static and dynamic backgrounds, attention was directed to generating background tables using the channel-azimuth 2D LiDAR data structure. For a specific LiDAR sensor, a blank 2D background table can be created based on the sensor's configuration and the frequency of rotation. The blank table will first be updated to an initial background table by studying the static background information, and then to a final background table by learning dynamic background information. This final background table is a critical input for background filtering of raw LiDAR data packets.

Under the channel-azimuth 2D LiDAR data structure, the range value of each data point from the identified static and dynamic backgrounds is saved in the corresponding table cell based on its channel and azimuth information. Since all background data need to be filtered, the minimal range value is chosen as the distance threshold for each table cell. For example, the range thresholds of the two static backgrounds shown in FIGS. 5A and 5B can be saved in a corresponding table cell as 20.97 meters and 19.18 meters, respectively.

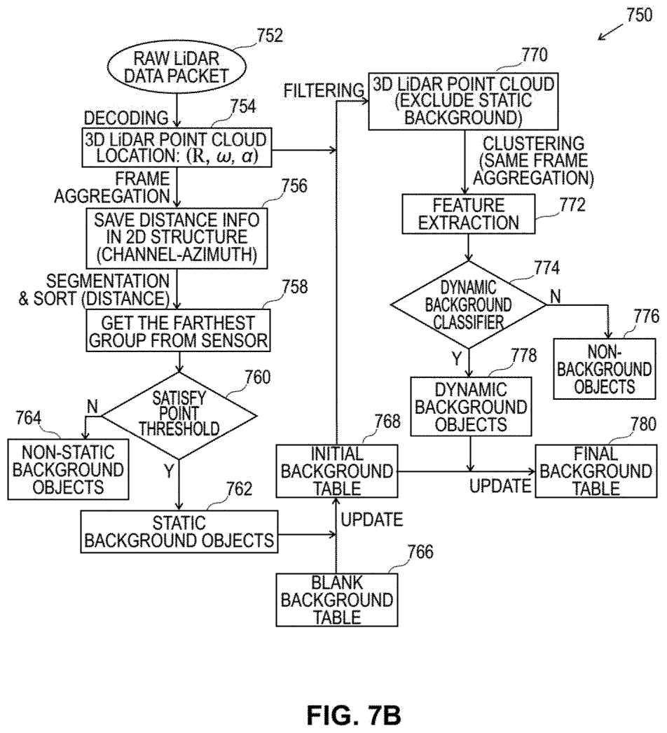

The complete procedure of static and dynamic background identification and background table generation is illustrated by the flowchart in FIG. 7, which is discussed below.

### Background Filtering of Raw LiDAR Data Packets

The goal of background filtering for roadside LiDAR data is to exclude the maximum amount of background objects while at the same time keeping the target objects as complete as possible.

Background Filtering in a 2D LiDAR Data Structure

Background filtering is executed based on a comparison of the distances between raw LiDAR datapoints and pre-saved background datapoints. According to the working principle of LiDAR sensors, whether the target object is measured by positive or negative laser beams, the 3D distance between the target object and the LiDAR sensor is always less than the 3D distance between the background object and the LiDAR sensor if these two objects are within the same azimuth interval and are measured by the same laser beam.

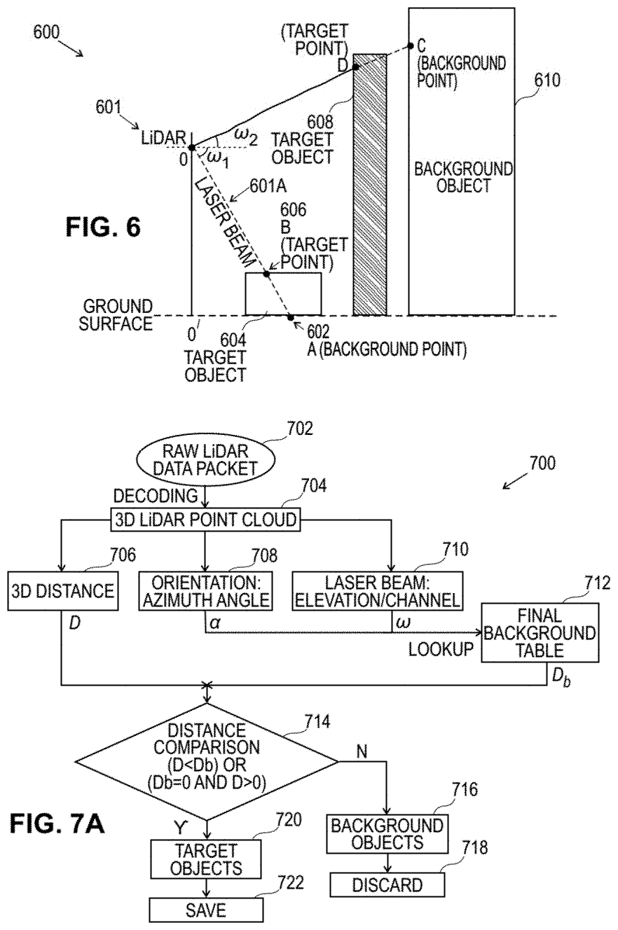

FIG. 6 depicts a diagram 600 illustrating how a LiDAR sensor determines target datapoints in accordance with aspects of the disclosed methods. In FIG. 6, a LiDAR sensor 601 emits a laser beam 601A and if there is no target object, then the negative laser beam (elevation angle ω₁) 601A propagates along a straight line to the ground surface point “A” 602 so that the distance of propagation is: d₁=OA. When a target object 604 is present then the same laser beam 601A with the same azimuth angle reaches a surface point “B” 606 of the target object 604 (before reaching the ground) and then the distance of propagation is d₂=OB, and d₂ is obviously less than d₁.

The same principle applies to the laser beams with positive angles: d₃=OC (to background object 610) and d₄=OD (for target object 608), wherein d₄ is less than d₃. Therefore, if the distance of a datapoint is less than the distance of the corresponding background datapoint, then this datapoint is considered as a target datapoint and should be saved. Additionally, a large portion of the distance threshold values in the final background table are zeros because there are no background objects at the location. Under such circumstances, if the measured distance of a raw datapoint is greater than zero, this datapoint is considered a target datapoint and saved.

After decoding the original data packet, a raw datapoint “A” is considered to be measured by a laser beam with a vertical angle ω at an azimuth angle α and the distance from the LiDAR sensor is D. Based on the channel and azimuth information, distance threshold D_{b} of the corresponding background can be found from the final background table. The criteria for determining the point A as a target datapoint are:

(D<D_{b}) OR (D_{b=}0 AND D>0)

Otherwise, point A is a background datapoint and will be discarded.

FIG. 7A is a flowchart 700 illustrating a background filtering process in accordance with disclosed methods. A computer processor of roadside LiDAR sensor system computer receives 702 raw LiDAR sensor data, then decodes 704 the raw LiDAR sensor data into a three-dimensional (3D) point cloud of datapoints, and extracts 3D distance data 706, azimuth angle data 708 and elevation data 710 from the 3DS point cloud. Next, the computer processor generates 712 a background table of datapoints utilizing the azimuth angle data and the elevation data and then compares the 3D distance data 706 to the datapoints comprising the background table 712. The computer processor next determines 714 based on the comparisons, static and/or dynamic background object datapoints 716, and then discards 718 those static and/or background datapoints. In addition, the computer processor identifies 720 target datapoints and then saves 722 the target datapoints in a storage device.

FIG. 7B is a flowchart 750 illustrating a method for generating a final background datapoint table according to the disclosure. A computer processor of roadside LiDAR sensor system computer receives 752 raw LiDAR sensor data, then decodes 754 the raw LiDAR sensor data into a three-dimensional (3D) point cloud location data, aggregates and saves 756 distance information in a two-dimensional structure 756, and segments and sorts the distances to obtain 758 datapoints which are the farthest from the LiDAR sensor. The computer processor next determines 760 whether the datapoints satisfy a point threshold, and if so classifies 762 the datapoints as static background objects 762, but if not classifies 764 the datapoints as defining non-static background objects. The background object datapoints are then inserted into a blank background table 766 to form an initial background table 768 which is used to filter the decoded LiDAR sensor data 754 to generate a 3D LiDAR sensor point cloud 770 that excludes the static background objects. A clustering process is then used 772 to extract features, and the computer processor next uses a dynamic background classifier 774 to generate non-background object datapoints 776 which are target datapoints and to generate dynamic background object datapoints, and in some implementations the target datapoints are stored in a storage device (not shown). Next, the computer processor updates the initial background table to generate 780 a final background table.

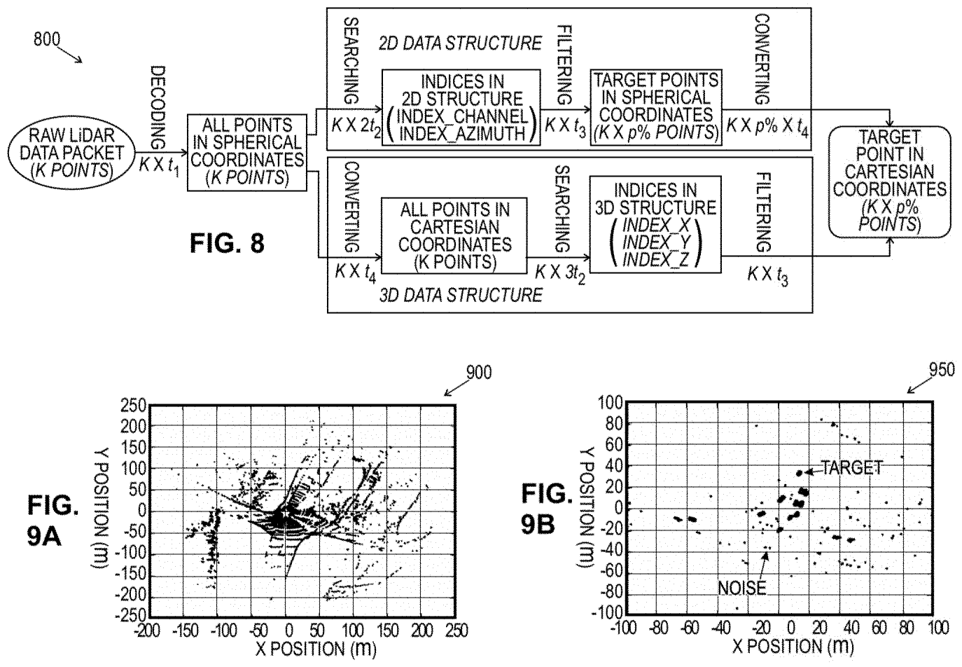

FIG. 8 is a functional block diagram 800 comparing methods for processing raw LiDAR sensor data via a two-dimensional (2D) and a three-dimensional (3D) data structure. It should be noted that processing 2D structure data saves a significant amount of computation time as compared to processing 3D structure data.

Given a LiDAR frame with K points, in which p% and (1−p%) of the points are target points and background points, respectively. The time for processing each individual data point is composed of:
t1: the time for decoding the raw data,
t2: the time for finding the location index along one dimension under the chosen structure,
t3: the time for determining background or target objects, and
t4: the time for converting spherical coordinates to Cartesian coordinates.

Using the proposed 2D LiDAR data structure, the total calculation time can be calculated by (as shown in FIG. 8):

T_{2D}=K×t₁+K×(2t₂)+K×t₃+K×p%×t₄ (1)

Using the traditional 3D LiDAR data structure, the total calculation time is (also shown in FIG. 8):

T_{3D}=K×t₁+K×t₄+K×(3t₂)+K×t₃ (2)

Therefore, the quantitative difference between T_{3D} and T_{2D} is:

ΔT=T_{3D}−T_{2D}=K×t₂+(1−p%)K×t₄ (3)

Where the first term involves finding an additional location index along the third dimension of all data points, and the second term refers to the unnecessary coordinate transformation of background points.

In roadside LiDAR applications, the percentage of target points is usually substantially smaller than that of background points. For example, a 16-channel LiDAR sensor (10 Hz rotation frequency) collects nearly K=30,000 points/frame and only p=5% of them are target points, which means that in the coordinate transformation step only, the proposed method would be 20 times faster than the traditional 3D structure-based methods (1,500 vs. 30,000, because K×p%=1,500 from Eq. (2), and K=30,000 from Eq. (3)).

In order to evaluate accuracy, one 16-laser and two 32-laser LiDAR sensors with 10 Hz rotation frequency manufactured by the Velodyne LiDAR company were installed at three intersections to collect pedestrian and vehicle data. The collected raw data was used to evaluate the background filtering method, and the size of the 2D background table for the 16-laser and for the 32-laser sensor is 16×1800 and 32×1800, respectively. It was shown that the background filtering process disclosed herein achieved an average background filtering rate of 99.74% and an average target retention rate of 98.57% for the 16-laser sensor data. In addition, the method achieved a relatively higher target retention rate (99.05%) while maintaining a considerable background filtering rate (99.77%) for the 32-laser sensor data.

FIG. 9A is a graphical representation 900 of a test example, before background filtering, of a total of 57,888 raw datapoints that were received, which included 5,644 target points (14 vehicles) and 52,244 background points (buildings, ground surfaces, trees, etc.). FIG. 9B is a graphical representation 950 of the test example of FIG. 9A after background filtering, wherein only 9.92% of the raw data were saved, which includes all target objects and some noise outliers that can be removed later by using a clustering process. Thus, in this example the total number of data points were reduced to 5,743, consisting of 144 background datapoints and 5,599 target datapoints. The overall background filtering rate was 99.72% and the retention rate was 99.2% for this data frame.

An evaluation of the processing speed indicates that, on average the decoding-based method took only about 0.65 milliseconds to process a single data frame collected by the 16-channel LiDAR sensor, and only took 0.90 milliseconds for the 32-channel LiDAR sensor (10 Hz rotation frequency). With similar background filtering rate and target retention rate, the disclosed method is over 77 (16-channel sensor) and 154 times faster (32-channel sensor; 0.65 ms/frame vs. 50 ms/frame and 100 ms/frame) than other known methods.

In addition to speed and accuracy, data storage is another problem which needs to be considered in practice. A key component of decoding-based background filtering is the 2D background table, which is used throughout the entire process. Saving a 2D table/matrix requires the memory space of:

S₁=M×N×B

where S₁ is the total storage space of a 2D table; M is the number of rows in the 2D table (channel); N is the number of columns in the 2D table; B is the number of bytes in each cell of the 2D table. For example, saving a 2D background table for a 16-laser LiDAR sensor (10 Hz) using the 2D data structure in MATLAB requires 16×1800×8=230,400 bytes=225 KB memory. Similarly, saving a 2D background table for a 32-laser LiDAR sensor (10 Hz) using the 2D data structure in MATLAB requires 32×1800×8=460,800 bytes=450 KB of memory. Even though the value of M is determined by the sensor's rotation frequency, the required memory has nothing to do with the size of the detection space. Storing a 3D matrix of datapoints would require a much larger memory space on the order of 1,250,000 KB or 1,220 MB of memory.

The disclosed background filtering method advantageously integrates the background filtering within the process when the original LiDAR data packet is decoded and provides a significant efficiency improvement as compared to conventional methods. A critical component of the method is the creation of a new 2D background table that automatically learns the critical distance information of both static and dynamic backgrounds. Moreover, the present decoding-based method outperforms known methods for roadside LiDAR applications, and also outperforms methods commonly used for onboard LiDAR applications. In addition, the process provides a major breakthrough in processing speed which lays a solid background for real-time application of infrastructure-based LiDAR sensors in connected vehicles and for infrastructure systems. The new method may also beneficially be integrated with clustering and tracking algorithms.

### II. Fast Spherical Projection Based Point Cloud Clustering Process

Object Clustering and Identification

In another aspect, disclosed is a fast clustering method based on a two-dimensional (2D) map process. Datapoint cloud clustering is an important component for processing roadside LiDAR traffic data. The clustering algorithm has a profound effect on the accuracy and efficiency of object detection and further impacts the effectiveness of roadside LiDAR applications such as LiDAR based connected-vehicle systems. In some disclosed embodiments, a fast clustering process is based on a spherical projection map that provides improved detection accuracy and lower computational complexity as compared to conventional methods. The fast clustering method also enables a wider detection range and improved robustness. Reasons for the improvement include the adoption of a 2D searching window and the use of a spherical map which greatly improves the time complexity of a neighborhood query in the clustering process and provides less sensitivity to varying point densities. In some implementations, the Fast Spatial Clustering process is based on a two-dimensional map (FSCTD) method and may be implemented using the Python coding language or other programming languages.

The first step for FSCTD is to convert 3D coordinates into a 2D map by using spherical projection. As explained earlier, for a datapoint in the 3D space, in addition to XYZ coordinates, it could also be described by Azimuth α, Zenith θ and Distance d, where the α and θ refer to the horizontal and vertical angle respectively, and d refers to the distance from the LiDAR sensor to the point. Basically, the idea is to project the distance value of each point onto a 2D map according to the corresponding spherical information: azimuth and zenith. The greatest advantage of converting to a spherical map is that image processing can occur with regard to the 3D datapoint cloud.

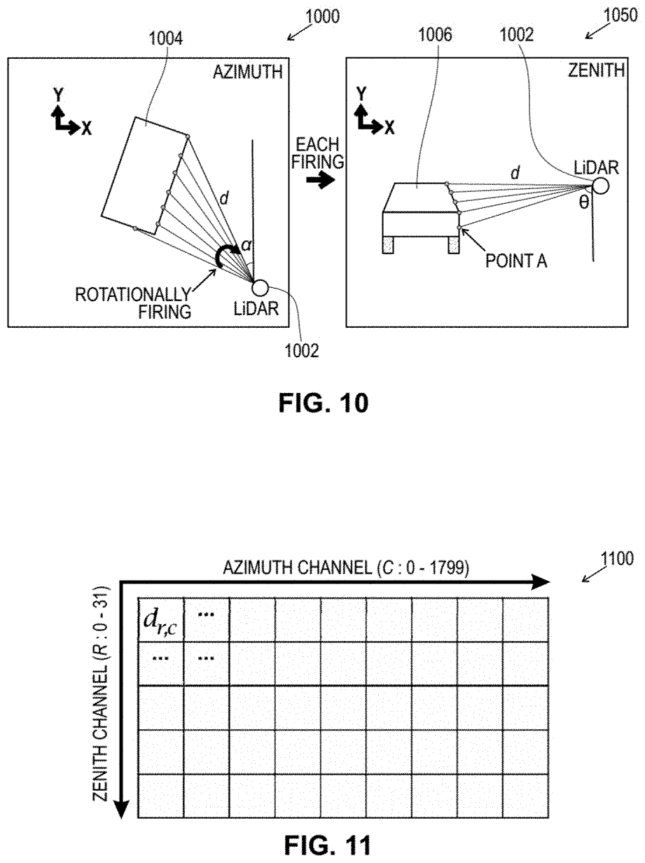

FIG. 10 includes azimuth and zenith block diagrams 1000 and 1050 illustrating how data is obtained by a LiDAR sensor. In particular, the LiDAR sensor 1002 collects point cloud data by rotationally firing vertically arranged laser beams (not shown) and receiving data reflected from an object 1004, 1006, and a set of datapoints are collected at each firing which is dependent on the number of different vertical arranged laser scanners (zenith channels). Some laser scanners are not evenly arranged but are instead arranged by different fixed zenith angles. A frame is collected when a 360° rotation is completed containing m×n points, where “n” denotes the number of azimuth discretions (n firing per 360° rotation) and “m” is the number of different zenith channels (m points per firing, for example there are 32 for a 32-laser LiDAR sensor).

FIG. 11 illustrates a spherical map 1100 which is defined as a 2D map whose row and column represent the azimuth discretization and zenith channels respectively. According to the general setting of a LiDAR sensor, a 360° rotation would approximately return 1800 firings which is 32×1800 points per frame. To project the whole point cloud in a frame, the spherical map requires a scale of 32×1800. Referring to FIG. 11, the term d_{r,c} denotes the distance value of the r^{th} vertically arranged zenith angle and the c^{th} azimuth discretization.

The Fast Spatial Clustering based on Two-Dimensional Map (FSCTD) Process

The FSCTD process is based on the known Density-Based Spatial Clustering of Applications with Noise (DBSCAN) method. The DBSCAN process is a prevalent algorithm for using in performing a clustering task, as it identifies arbitrary shaped clusters according to their spatial density while also ruling out noise. In general, two parameters are involved in the DBSCAN: “minPts” (minimum sample points to establish a core point) and “eps” (neighborhood searching radius). DBSCAN operates as follows: First, for each point, search the neighborhoods in an eps-radius, and mark those points whose number of neighborhoods within the eps-radius satisfy the minPts threshold as core points. Second, identify the connected components of the core points based on the direct and indirect interconnection of neighborhoods, and ignore the non-core points. Third, assign each non-core point to a nearby connected component if the non-core point is within the eps-radius, otherwise the non-core points are labeled as noise.

As suggested in the DBSCAN process, time complexity is composed of two parts: 1) the time for checking the core points, which consumes O(N); and 2) the time for searching the neighborhoods, which consumes O(N) per point as a worst case situation. If a data structure such as a KD-Tree is applied to improve the neighborhood searching, the time complexity would be improved O(log(N)). Therefore, the total time complexity is O(N²) to O(Nlog(N)). For data associated with heavy traffic conditions that involves many moving objects, the large number of foreground points would exponentially increase the time needed for performing the clustering process, which results in a lag that is not optimal for a real-time response in roadside LiDAR applications.

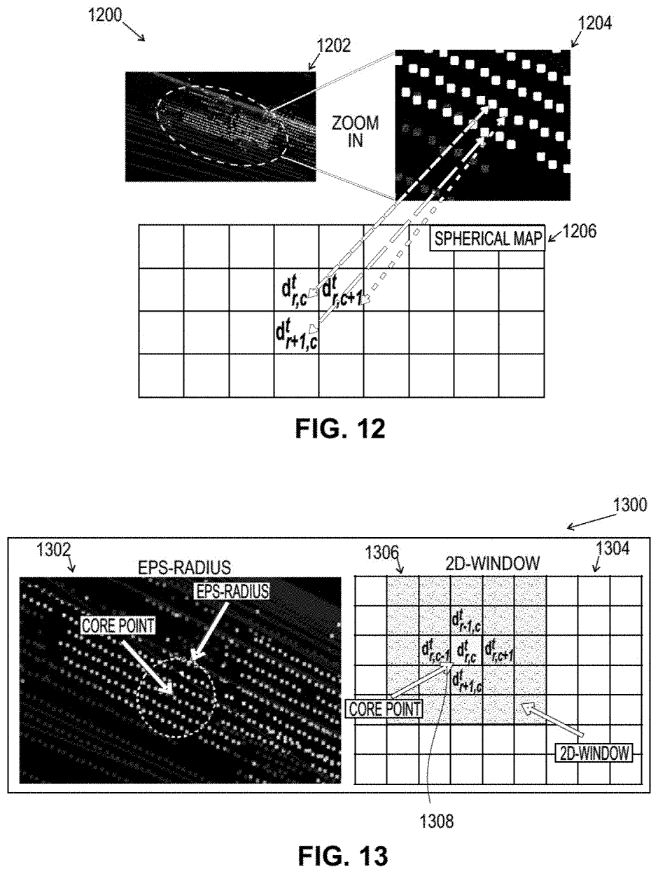

The FSCTD process includes a modification of the neighborhood searching part of the DBSCAN process. Compared to DBSCAN, the FSCTD searches the neighborhoods on the spherical 2D map, which improves efficiency and accuracy. FIG. 12 is a spherical map representation 1200 of the point arrangement of a vehicle (marked by the dotted circle 1202) in both spherical map and 3D space. If we zoom in the points 1204, it can be observed that three points are neighborhoods between each other in 3D space, and these three points locate at neighbor cells on the spherical map 1206. Based on this observation, the spatial relationship between points could be directly inferred on the spherical map by comparing the indices of neighbor cells.

FIG. 13 provides a comparison 1300 of the neighborhood searching approach between the DBSCAN process and the disclosed FSCTD process. The Eps-Radius diagram 1302 is a result of conducting neighborhood searching via the DBSCAN method, which is based on a spatial eps-radius. The 2D-Window graph 1304 is a result of conducting neighborhood via the FSCTD method, which is based on 2D-window searching. For spatial eps-radius searching, the spatial relationship between each pair of points is first interpreted from the input data by calculating the Euclidean distance or by establishing a tree-based data structure such as KD-Tree, which requires O(N) and O(log(N)) time complexity, respectively.

Referring again to FIG. 13, the area 1306 is a 2D-window having a 5×5 size (it should be noted that the size of 2D-window can be arbitrarily determined in practice, for example 3×11 size window is also viable). To query the neighborhoods using the 2D-window, two steps are required: 1) the row r and column c indices for the cells within the 2D-window are first calculated based on the central point 1308 (or core point), and the neighbor cells within the 2D-window |d_{r,c}|r, c ∈ window) are directly read from the TD-MAP according to the indices; 2) those readings whose distance d_{r,c} satisfy the criterion d_{center}−d_{reading}|<ε are selected as neighborhoods;

In this criterion, the term ε is another parameter utilized by the FSCTD process to exclude datapoint readings whose distance deviate too far from the center point, which is necessary because even though two points are close to each other on the spherical map they may still be far in 3D space. Since the neighborhood query using the 2D-window only focuses on the cells within the window, the time complexity is independent from the whole problem scale N, and thus the time complexity for 2D-window searching is O(1) and the whole complexity for FSCTD is O(N).

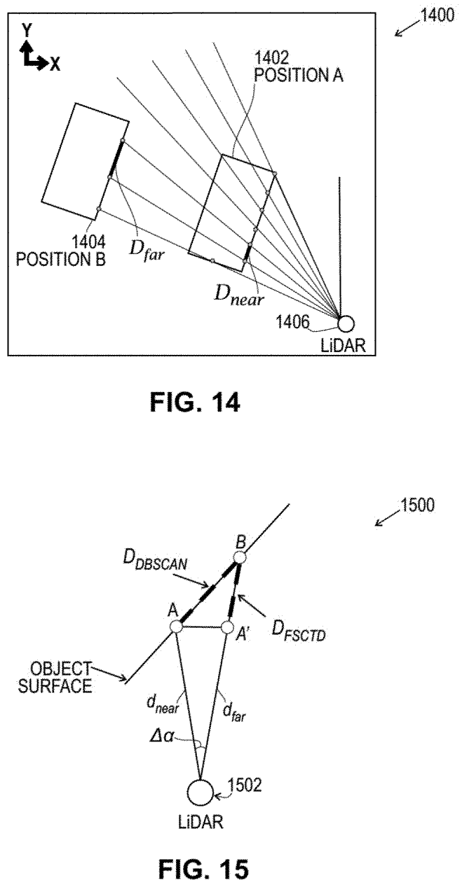

Another advantage for FSCTD is its robustness to the variation of point density problem, which improves both accuracy and range of detection. FIG. 14 is a graph 1400 illustrating the point density variation problem. The density of the object at position A 1402 is much higher as compared to the same object at position B 1404 (far side), which is caused as the laser beams radiate outwardly from the LiDAR sensor 1406. For common Euclidean distance based methods, the varying point density (or distance between each adjacent point) may cause many False Negative cases (wherein target objects cannot be detected). For example, when using DBSCAN, due to the difference of D_{far} and Dₙₑₐᵣ shown in FIG. 14, it is difficult for the DBSCAN to correctly cluster both far and near objects using a fixed eps-radius threshold. If the eps threshold is set large enough to cover D_{far}, different entities at the near side may be clustered as one cluster. On the other hand, if the eps-radius is set as a small value so as to correctly cluster near objects as independent entities, objects at the far side may not be detectable due to the sparseness of reflected laser beam points.

Use of the FSCTD process avoids the “sparseness” or impact problem because: 1) for objects at the far side, even though the distance of two adjacent points is large, the two points are still near each other on the spherical map due to the rotational characteristic of a LiDAR sensor; and 2) the parameters in FSCTD can be tuned to detect both near and far sides of objects correctly.

Specifically, FIG. 15 is a diagram 1500 illustrating the difference of DBSCAN and FSCTD in considering spatial distances between point A and point B. In particular, the points A and B denote the two adjacent points on the object surface, where point A is relatively nearer than point B because of the angle of the object surface in relation to the LiDAR sensor 1502, and A′ is the projection on the trace from the LiDAR sensor 1504 to point B. The designations dₙₑₐᵣ and d_{far} refer to the distance from LiDAR sensor 1502 to points A and B respectively. The segments D_{DBSCAN} and D_{FSPC} are the corresponding distance measurements for DBSCAN (Euclidean Distance) and for the FSCTD algorithm. According to the geometry relationship, the segments D_{DBSCAN} and D_{FSPC} could be described as following equations:

D_{DBSCAN}=d_{far}²+dₙₑₐᵣ²−2dₙₑₐᵣd_{far} cos(Δa) (1)

D_{FSPC}=d_{far}−dₙₑₐᵣ (2)

In this case, the Δα is the delta azimuth angle between two horizontal beams, which is a constant equaling to 0.2 degree, hence cos (Δα) approximates to 1 and the term 2dₙₑₐᵣd_{far} cos(α) is approximately equal to 2dₙₑₐᵣd_{far}. Thereby the D_{DBSCAN} could be rewritten as (d_{far}−dₙₑₐᵣ)². Assuming that d_{far}=γdₙₑₐᵣ, then D_{FSCTD} and D_{DBSCAN} could be recognized as:

D_{DBSCAN}=(γ−1)²dₙₑₐᵣ² (3)

D_{FSPC}=(γ−1)dₙₑₐᵣ (4)

Where γ is an amplification factor which determines the heading degree of the object surface and which is greater than 1. It could be inferred that the D_{FSPC} is less sensitive compared to D_{DBSCAN} since the D_{FSCTD} is increased linearly while the D_{DBSCAN} is increases exponentially with the distance. Thus, FSCTD easily identifies the appropriate threshold to separate entities in both the far and the near side because the distance measurement for FSCTD only increases by a small extent. For example, the Euclidean distance between adjacent points would increase 10000 times from the 1 m to 100 m whereas the distance measurement for FSCTD only increases 100 times.

The output of FSCTD is a Labeling map with identical size as the spherical map, where each cell stores the point-wise instance label. The Labeling map could be decoded as 3D point coordinates associated with the spherical information provided on the spherical map.

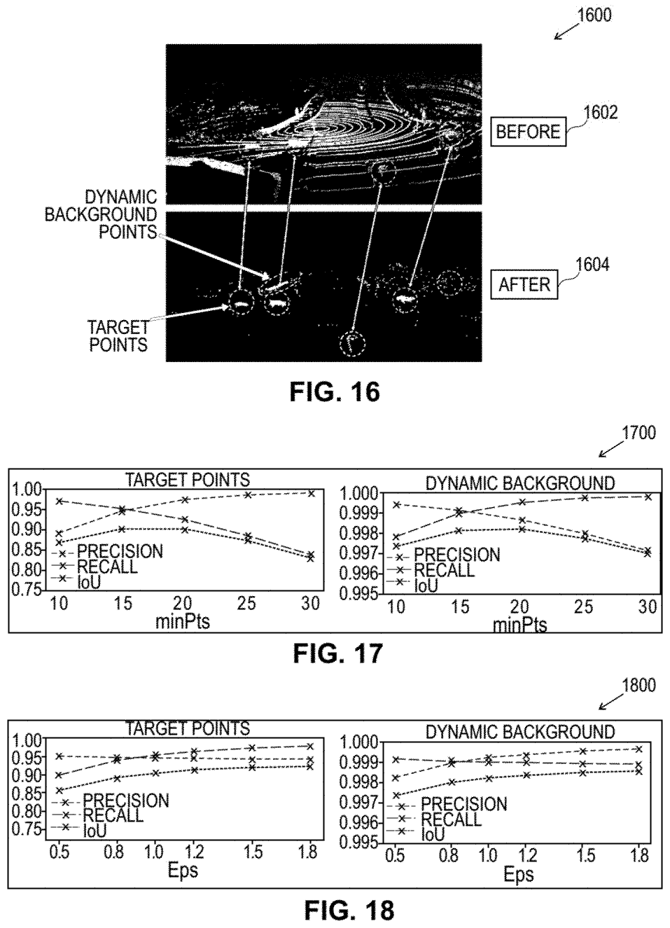

The FSCTD was tested on a dataset including 18,000 frames (half an hour) of post-filtering point clouds processed by the background filtering method. Among which 2000 frames were manually labeled with a point-wise classifier (target object or background object). FIG. 16 depicts a visualization 1600 of the before 1602 and after 1604 post-filtered point cloud. Only target points and scattered noise caused by the random nature of the LiDAR sensor are contained in the data, and on average 1,699 foreground points are contained in each frame wherein approximately 40% of the datapoints are scattered background points that are required to be excluded by using a clustering process. The FSCTD process was first tuned on the labeled dataset to obtain the optimal parameters. Next, the scores including accuracy and time consumption of FSCTD were obtained through the labeled dataset and a comparison was made to the DBSCAN. Lastly, the FSCTD with the optimal parameters was tested on the entire dataset to validate the detection range and time complexity. The processing was performed using a desktop PC with an Intel Core i5-7500 3.40 GHz processor and 16GB RAM, but other types of computers and/or computing devices could have been utilized.

As mentioned in the methodology, three parameters: E(eps), size of 2D window and minPts are involved in the FSCTD process. For evaluation purposes, the best combination of different parameters is first tuned to obtain optimal performance. Use of a conventional DBSCAN (provided by skit-learn library) was also included for comparison. Since we only focus on the detection of target objects (all road users), the total classes in the clustered results are comprised of dynamic background (noise object left after background filtering) and target points (foreground) as labeled in the after visualization 1604 of FIG. 16. The metrics for image segmentation were selected for the performance evaluation because the output (Labeling map) has the same property as a labeling mask in the image segmentation tasks. The selected metrics include precision, recall and IoU (intersection-over-union). The point-wise ground-truth labels are compared with the output of FSCTD and the metrics were calculated. The calculation can be defined as follows:

$${precision}_{c} = \frac{\vert {O}_{c} ⋂ {G}_{c} \vert}{\vert {O}_{c} \vert} , {recall}_{v} = \frac{\vert {O}_{c} ⋂ {G}_{c} \vert}{\vert {G}_{c} \vert} , {IoU}_{c} = \frac{\vert {O}_{c} ⋂ {G}_{c} \vert}{\vert {O}_{c} ⋃ {G}_{c} \vert} \qquad ( 5 )$$

Where O_{c} and G_{c} respectively refer to the output and ground truth point sets belonging to class c. The symbol |·| denotes the cardinality (number of points) of the point set.

The parameter searching range is presented in the following table, which was determined empirically.

TABLE 1
Parameter Searching Range

| Parameter | Algorithm | Searching Range |
|---|---|---|
| Eps | FSCTD | [0.5, 0.8, 1.0, 1.2, 1.5, 1.8] |
| | DBSCAN | [0.5, 0.8, 1.0, 1.2, 1.5, 1.8, |
| | | 2.0, 2.2, 2.4, 2.6, 2.8, 3.0] |
| minPts | FSCTD | [10, 15, 20, 25, 30] |
| | DBSCAN | |
| Height of window | FSCTD | [2, 3, 4, 5, 6, 7, 8] |
| Width of window | | [7, 9, 11, 13, 15, 17, 19, 23, 27] |

The tuning starts from the parameter minPts. FIG. 17 depicts graphs 1700 presenting the average score of metrics given different minPts settings. The score of three metrics for the dynamic background is very high regardless of the change of minPts, and all of the scores exceed 99.7%. As for the target points, the precision and recall values increase below 20 minPts and begin at 97.4% and 90.2% respectively. However, the recall value keeps decreasing over the entire range. In the application of roadside LiDAR sensors, recall should be prioritized over the precision and thus the optimal value for minPts should be 15.

Given a 15 minPts setting, the parameter setting of eps was also tested, and the graphs shown in FIG. 18 depict the average metrics given different Eps values. Similar to the previous test, the dynamic background metrics are maintained at a high level. For the target points, the precision changed slightly from 95.1% to 94.3%, whereas the recall and IoU values improved over the whole eps range, reaching 98.0% and 92.5% respectively. Thus, the best Eps value is 1.8.

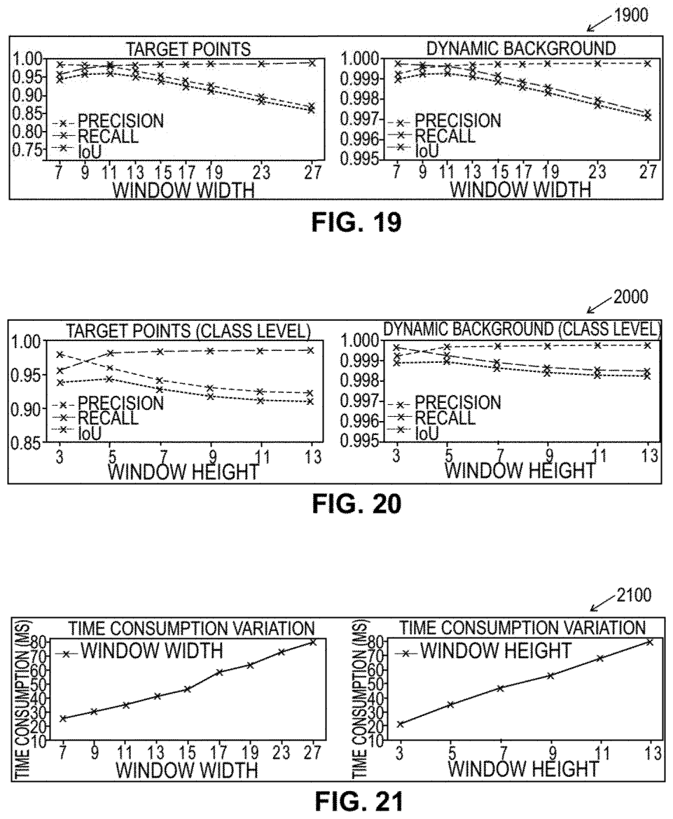

Next, the size of the searching window (Window Width) was tested, which includes two parameters: height and width. The window size significantly affects the searching range and the computation load, and thus it was tested in association with time consumption. FIG. 19 and FIG. 20 illustrate graphs 1900 and 2000 that depict the tested window height and window width. FIG. 21 depicts a graph 2100 showing time consumption variation. Again, the impact of different parameters concerning the dynamic background can be ignored, and as showed in the FIG. 19 the precision and IoU are affected significantly by the window width. Thus, a longer window width contributes to lower metric values after the window width increased beyond 11, and finally decreased to 86.8% and 85.8% respectively, at a window width of 27 while the recall increased over the whole range. Obviously, the increment for the width has limited improvement for the recall, however largely decreased the recall and IoU. Additionally, as shown in the FIG. 21, the time consumption increases linearly as the width increases. Thus, taking a comprehensive viewpoint, the window width was selected as 11 and based on a similar analysis, a window height of 5 was chosen.

Based on the systematic analysis, the optimal parameter for FSCTD is summarized in Table 2 and the same analysis is implemented and shown for DBSCAN in Table. 2, below

TABLE 2
Optimal Parameters for Clustering Algorithm

| Method | Min sample | Eps | Window size |
|---|---|---|---|
| FSCTD | 15 | 1.8 | (5 × 11) |
| DBSCAN | 15 | 1.2 | / |

An overall summary of metrics based on best parameters setting is shown in Table 3, below. Beside, an instance level error between the number of detected object and ground truth is introduced to adequately represent the performance. The instance level error is calculated by counting the instances number that have instance-IoU over 50% between output and ground truth. It can be seen that the FSCTD process outperforms traditional DBSCAN at all metrics. The precision, recall and IoU for target points could reach to 98.2%, 98.3% and 96.5% respectively. Based on the metrics for background points, it is indicated that over 99% of the dynamic background points could be ruled out by both algorithms. In total 1511 ground truth instances, of which 1483 are correctly detected with over 50% IoU, while the traditional DBSCAN only tackled 1414 with lower IoU. Most importantly, the FSCTD process is faster and more robust as compared to DBSCAN. FSCTD on average only takes 24.4 ms/frame to process a frame, but within the same dataset, DBSCAN takes 117.1 ms/frame to process a frame. Also, the standard deviation of the time consumption for FSCTD is 2.36 but is 6.59 for DBSCAN, proving that the FSCTD process is more robust.

TABLE 3
Performance Evaluation Result

| | | | | | | | Matched |
|---|---|---|---|---|---|---|---|
| | | | | | μ_{cost} | σ_{cost} | Instances |
| Method | Class | Precision | Recall | IoU | (ms) | (ms) | (IoU > 0 0.5) |
| FSCTD | Target | 98.2% | 98.3% | 96.5% | 24.4 | 2.36 | 1483/1511 |
| | Point | | | | | | |
| | Dynamic | 99.9% | 99.9% | 99.9% | | | |
| | Background | | | | | | |
| DBSCAN | Target | 82.3% | 96.7% | 80.0% | 117.1 | 6.59 | 1414/1511 |
| | Point | | | | | | |
| | Dynamic | 99.9% | 99.6% | 99.5% | | | |
| | Background | | | | | | |

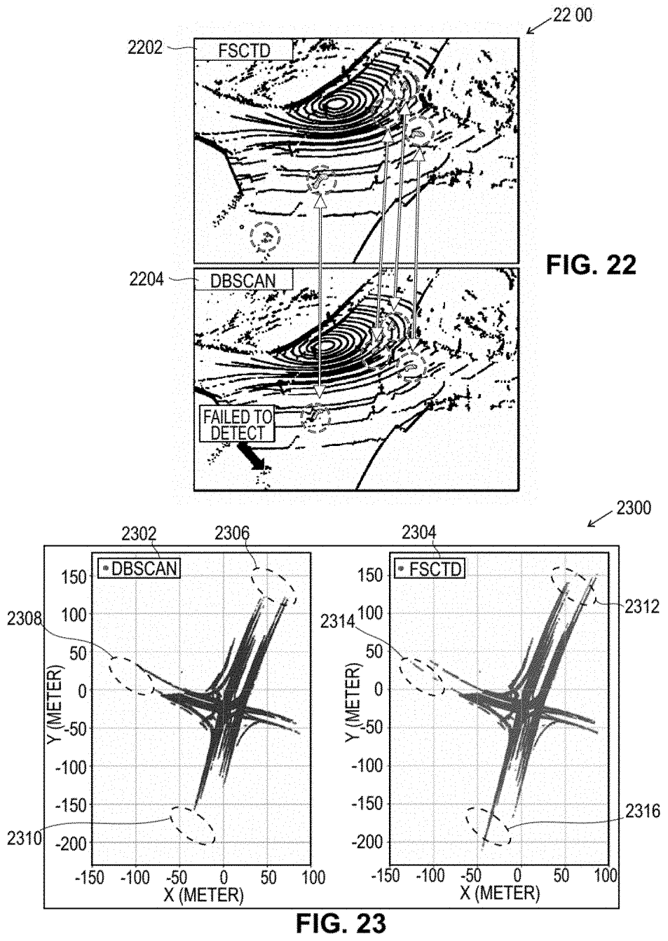

The major reason for the accurate result can be attributed to solving the variant density problem by using the TD-MAP structure and 2D-window searching, which was explained above. FIG. 22 is a 3D visualization 2200 of the improvement of the FSCTD process over using the DBSCAN process. As shown in FIG. 22, the FSCTD process results 2202 show detection of five (5) objects while the DBSCAN results 2204 show detection of only 4 objects. The missing object in the DBSCAN results 2204 occurs in the lower-left corner, wherein sparser point cloud data is available (as compared to other processes) because the eps-radius of DBSCAN is better for detecting objects that are closer to the LiDAR sensor than it is for detecting objects that are far away from the LiDAR sensor.

FIG. 23 shows two graphs 2300 showing visualizations of the same intersection for comparing the detection range of the DBSCAN process 2302 and the FSCTD process 2304. As shown, both graphs show that these processes can provide data to visualize the outline of the road intersection, but the DBSCAN process failed to detect objects within circles 2306, 2308 and 2310 which are detected by FSCTD shown within circles 2312, 2314 and 2316, which objects are mostly located at a distance of over 100 meter away from the roadside LiDAR sensor. In fact, the detected object 2316 furthest away from the LiDAR sensor and detected by using the FSCTD process is located over 200 meters away.

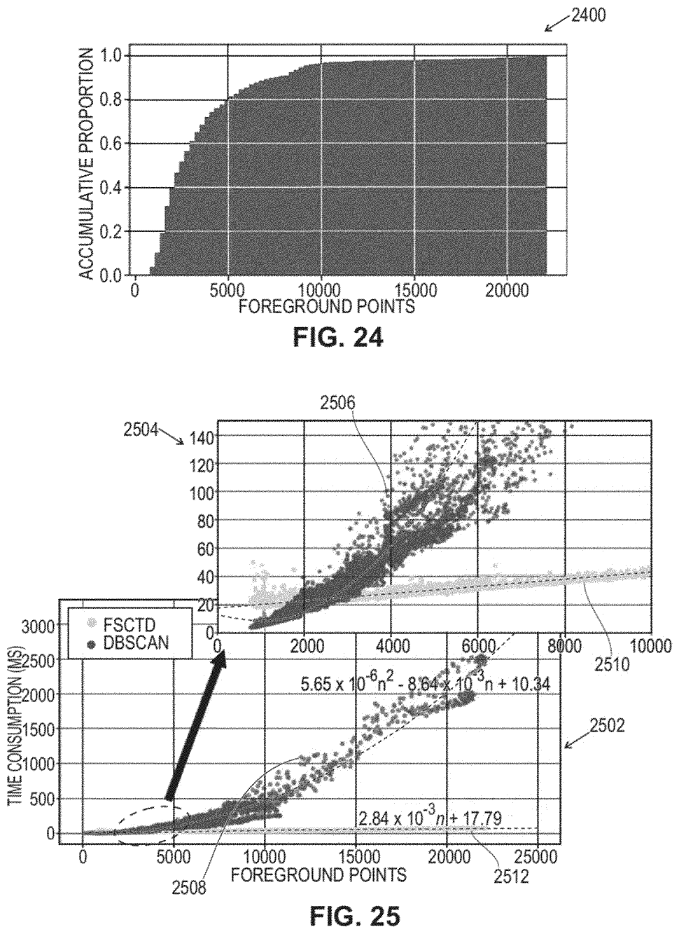

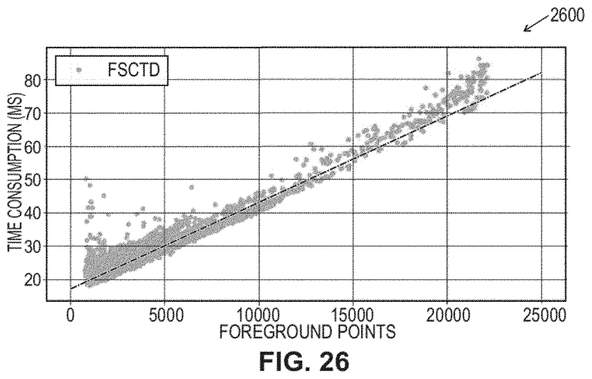

For roadside LiDAR traffic data processing, the robustness to variant computation loads is important since the foreground points can periodically surge due to the nature of traffic along a road or intersection. For this concern, the impact of the number of foreground points to algorithm efficiency was tested, and FIG. 24 is a chart 2400 of the foreground data points accumulated across 18,000 frames in an intersection. As shown in FIG. 24, over 90% of the reported frames contain less than 10,000 foreground points and approximately 10% of the frames have more than 10,000 foreground points resulting in 23,000 points. FIG. 25 depicts graphs 2502 and 2504 illustrating the correlation between the foreground points and the time efficiency of clustering. As shown, the time consumption of the DBSCAN process 2506 and 2508 increased significantly as the foreground points incremented, however the time consumption due to use of the FSCTD process 2510 and 2512 only increased a small amount. In fact, the maximum time consumption using the DBSCAN process 2508 reaches 2500 milliseconds (ms) for the most complex scene, which is devastating for real-time applications. As for the FSCTD process, as shown in the graph 2600 of FIG. 26 concerning the foreground points versus time consumption, the maximum time consumption does not exceed 85 ms for a number of foreground points over 20,000 (see also the time consumption plot 2512). In the most common scenes, the number of foreground points is typically less than 10,000, and in such cases the DBSCAN process would consume up to 500 ms, while in contrast the FSCTD process consumes less than 40 ms.

(It should be noted that the DBSCAN process can outperform the FSCTD process in a situation wherein the number of foreground points is less than 2000 because the FSCTD process consumes more of a computational load in the preprocessing steps, such as when establishing the TD-map. As a consequence, the time for preprocessing exceeds the time for conducting the clustering process. Nevertheless, the FSCTD process still outperforms the DBSCAN process when it comes to both efficiency and robustness in over 90% situations.)

The disclosed fast clustering process (FSCTD) efficiently and accurately clusters variant-density points by utilizing the spherical projected TD-Map and 2D-window searching to accelerate the clustering process and to advantageously alleviate the impact of the variant-density phenomenon. Test results showed that: 1) the FSCTD process achieves results within 30 ms/frame for the most common scenes (foreground points within 5000); and 2) over 96% of objects have over 50% IoU with instance-level ground truths, and over 98% in both precision and recall metrics. In addition, as compared to conventional DBSCAN use, the FSCTD process outperformed in all metrics with a processing speed that was 4.8 times faster and had a higher overall clustering accuracy of over 96%. In the time complexity analysis, the FSCTD process was not greatly impacted by the surge of foreground points and thus in over 90% of scenes the process time would be maintained within 40 ms. Additionally, a wider detection range was identified of up to 200 meters from the LiDAR sensor which is 33% longer than that for the conventional DBSCAN process. Accordingly, the high performance results of the FSCTD process can be beneficially used in practice to improve the roadside LiDAR sensor detection process. Moreover, the background filtering method disclosed herein, which is based on spherical mapping and a tracking algorithm, can be added before and/or after use of the FSCTD process when processing roadside LiDAR sensor data. In addition, it may be possible to improve the speed of the FSCTD process by utilizing coding techniques to further accelerate the processing speed.

### III. High Accuracy Roadway User Classification Using Prior Trajectory Information

New Object Classification Process

Another aspect associated with processing roadside LiDAR sensor data is a high-accuracy, feature-based road user classification process. The high-accuracy process disclosed herein utilizes prior trajectory information to classify vehicles, pedestrians, cyclists and wheelchairs. By updating significant features based on prior information of the entire trajectory, more critical features can be used as the input(s) of classifiers to increase classification accuracy. In an implementation, the process includes updating critical features based on prior trajectory information, which greatly improves the accuracy of classification, especially for classes having a small number of observations.

There is limited information available concerning classification of objects using roadside LiDAR, but a known process includes using an artificial neural network (ANN) classifier with three features (i.e., the number of points, the distance to LiDAR, and spatial distribution direction) extracted from a 16-laser LiDAR sensor to distinguish vehicles and pedestrians. Even though such LiDAR sensor systems have been shown to achieve 96% classification accuracy within a 30 meter (m) detection range, it is difficult for the trained classifier to further classify other types of road users such as cyclists and wheelchairs. Accordingly, weaknesses of existing roadside LiDAR classifiers include the short effective detection range and the limited types of road users that can be classified, and such short detection ranges and classification limitations fail to meet the detection and classification requirements necessary for multimodal traffic detection using roadside LiDAR sensors.

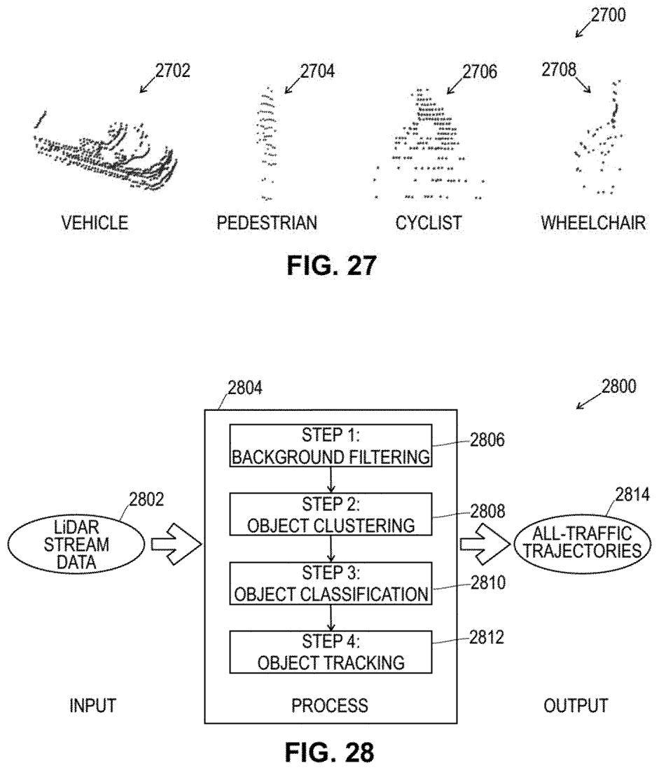

FIG. 27 is a visualization 2700 illustrating four different road user classifications in accordance with disclosed methods. Specifically, a feature-based classification process was combined with prior trajectory information to classify a vehicle 2702, a pedestrians 2704, a cyclist 2706 and a wheelchair user 2708 using roadside traffic data acquired by a roadside LiDAR sensor. Four classifiers were used and by updating critical features based on prior trajectory information, the accuracy of classification can be greatly improved, especially for classes with a small number of observations. In particular, the AdaBoost and RUSBoost classifiers showed superior performance in achieving the recall rate of vehicle (100%), pedestrian (99.96%), cyclist (99.74%), and wheelchair (99.43%) (The four classifiers are: 1)Artificial Neural Network, 2) Random Forest, 3)Adaptive Boosting (AdaBoost), and 4) Random Undersampling Boosting (RUSBoost).

### Trajectory Generation from Roadside LiDAR Data

LiDAR Sensor

As mentioned above, LiDAR sensors use a wide array of infra-red lasers paired with infra-red detectors to measure distances to objects, and such sensors are typically securely mounted within a compact, weather-resistant housing. The array of laser/detector pairs spins rapidly within its fixed housing to scan the surrounding environment and provide a rich set of point data in real time. LiDAR sensor configuration considerations include the number of channels, the vertical field of view (FOV), and the vertical resolution of the laser beams. In general, LiDAR sensors with more laser channels, larger vertical FOV and smaller vertical resolution are more productive in collecting traffic data. Installation considerations such as height and inclination of the LiDAR sensors also affect detection performance.

A study was conducted using the Ultra Puck (VLP-32C) LiDAR sensors manufactured by the Velodyne company. The Ultra Puck is a 360-degree LiDAR sensor with 32 laser beams and has a vertical FOV of −15° to +25°, but the distribution of the laser beams' vertical resolution is non-linear. A detailed configuration of the Ultra Puck LiDAR sensor is listed in Table A1 below.

TABLE A1
Configuration of Ultra Puck LiDAR sensor.

| LiDAR Type | Ultra Puck | |
|---|---|---|
| | (VLP-32C) | |
| Channels | 32 | |
| Measurement Range | 200 | m |
| Range Accuracy | Up to ±3 cm | |
| Horizontal FOV | 360° | |
| Vertical FOV | 40° (−15° | |
| | to +25°) | |
| Minimal Angular Resolution (vertical) | 0.33° (non-linear | |
| | distribution) | |
| Angular Resolution (horizontal/azimuth) | 0.1° to | |
| | 0.4° | |
| Rotation Frequency | 5 Hz to | |
| | 20 Hz | |
| Power Consumption | 10 | W |
| Weight | 925 | g |

| | |
|---|---|
| Operating Temperature | −20° C. |
| | to +60° C. |

### Roadside LiDAR Data Processing Procedure

FIG. 28 is a flowchart 2800 of a roadside LiDAR sensor data processing process in accordance with the disclosure. Specifically, a raw LiDAR data stream 2802 is input to a data handling process 2804 that includes background filtering 2806, object clustering 2808, object classification 2810 and object tracking steps 2812, which process 2804 generates 2814 high-resolution all-traffic trajectories data of all road users. In some embodiments, historical trajectory information is also integrated into the process to further improve the classification accuracy of the LiDAR data stream with regard to detection of vehicles, pedestrians, cyclists, and wheelchairs using the 32-laser LiDAR sensor.

### All-Traffic Trajectory

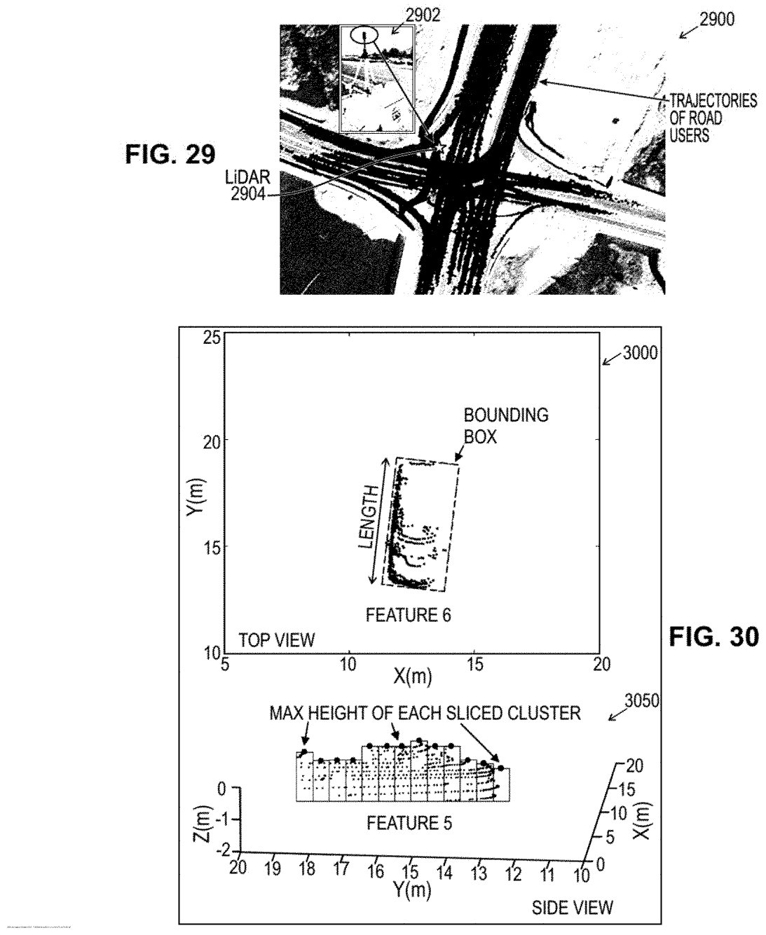

FIG. 29 is a visualization 2900 of geo-located trajectories extracted from a one half-hours' worth of data collected by a portable LiDAR sensor 2902 located at an intersection 2904. Utilizing the series of processing steps shown in FIG. 28, the trajectories of all road users can be obtained. In particular, in Step 4 2812 of FIG. 28, object tracking is designed to execute based on the representative reference point of each cluster, so the information of each extracted cluster in each data frame is saved at the end of Step 3 2810. To be more specific, the attributes of recorded cluster and trajectory information are summarized as follows:
1) Saved information of each data point from each cluster (output of step 3 2810) includes the ClusterID, the Classification label (vehicle=1, pedestrian=2, cyclist=3, and wheelchair=4), the X position (m), the Y position (m), the Z position (m), the Azimuth angle (degree), the Distance from the sensor (m), and the Frame number (timestamp).
2) Saved trajectory information of each object (output of Step 4 2812) includes the ClusterID, the Classification label (vehicle=1, pedestrian=2, cyclist=3, and wheelchair=4), the X position (m), the Y position (m), the Z position (m), the Distance from the sensor (m), the Longitude (degree), the Latitude (degree), the Elevation (m), the Speed (mph) and the Frame number (timestamp).

### Feature Engineering

Feature Selection

For supervised classification tasks, feature selection is a critical step in training classifiers. Good features should be able to effectively distinguish different classes and can be easily obtained from datasets. LiDAR sensors are good at accurately capturing the surface shape of objects, therefore, seven features can be extracted (five of them are related to dimensionality) from the point cloud of clusters for vehicle/pedestrian/cyclist/wheelchair classification.
Feature 1 (3D distance): the average distance value of each cluster from LiDAR sensors.
Feature 2 (Point count): the total number of data points in each cluster.
Feature 3 (Direction): the direction of the clustered points' distribution (horizontal or vertical). With the least-square linear regression method, a linear function can be generated to describe the main distribution direction of each cluster.
Feature 4 (Height): The difference between the maximal and minimal height (Z value) of each cluster.
Feature 5 (Height variance): the variance of the maximal height of each sliced cluster along the 2D length direction, as shown in FIG. 4.
Feature 6 (2D length): the longer side of the bounding box (e.g., the minimum rectangle that covers all clustered points based on the minimal and maximal values projected on XY plane) of each cluster, as shown in FIG. 4 (left).
Feature 7 (2D area): the 2D area of the bounding box of each cluster.

FIG. 30 illustrates a top view visualization 3000 and a side view visualization 3050 of features extracted from clusters in accordance with the disclosure. Specifically, the 2D length (Feature 6) is shown in the visualization 3000 whereas the height variance (Feature 5) is shown in the visualization 3050.

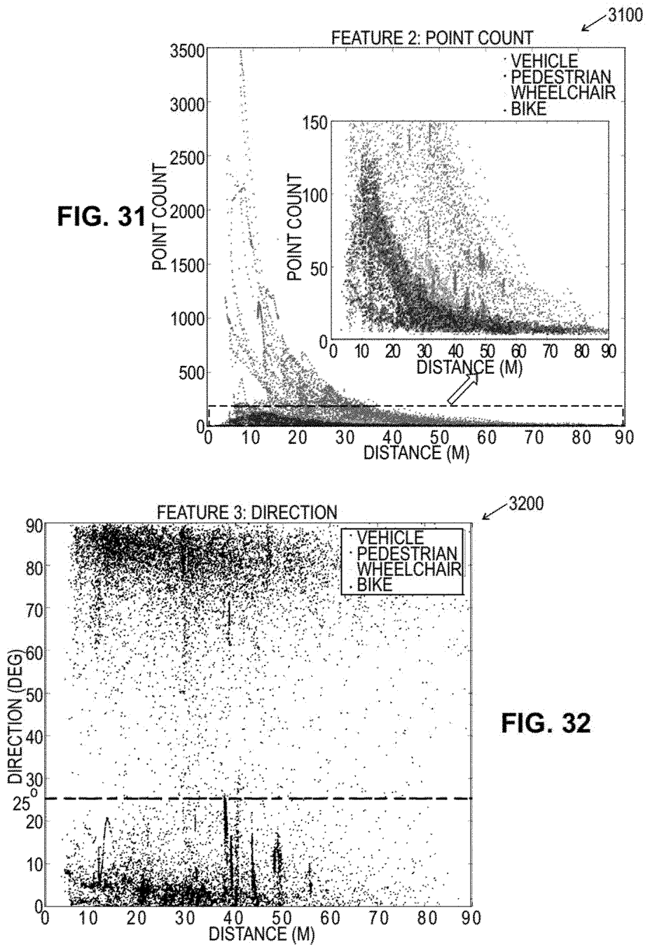

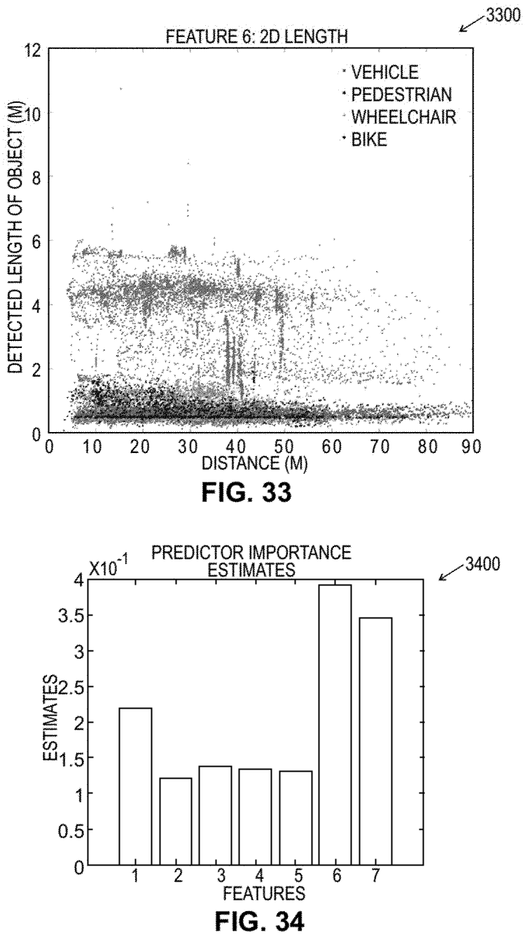

FIGS. 31, 32 and 33 are three plots which illustrate the Distance-PointCount 3100, Distance-Direction 3200, and Distance-Length 3300, respectively, distributions of the four types of road users. In FIG. 31 it is sufficient to understand that the number of points in one cluster dramatically decreases as the distance between the object and the LiDAR sensor increases. In general, vehicle clusters have more points than pedestrian/cyclist/wheelchair clusters at the same distance. In FIG. 32 it is sufficient to note that the difference between vehicle clusters and pedestrian/cyclist/wheelchair clusters changes in terms of the direction of the clustered points' distribution. When the direction angle of a cluster is less than twenty-five degrees (25°) there is a high possibility that this cluster is a vehicle. In FIG. 33 it is sufficient to note that this is a length characteristic analysis of different road users, which will be discussed below. By noticing the differences in the feature distributions shown in FIG. 33, it is not difficult to find that vehicles have a relatively obvious difference as compared to pedestrians, cyclists and wheelchairs. However, distinguishing between pedestrians, cyclists and wheelchairs is not straightforward.

Significant Features

With regard to analyzing the importance of features, when training with different classifiers, even though the ranking of feature significance was different, Feature 6 (2D length) always ranked first among the seven proposed features. For example, FIG. 34 is a graph 3400 of feature significance showing the feature significance ranking of the RUSBoost classifier, wherein Length>Area>Distance>Direction>Height>Height variance>Point count. The details of the trained classifiers will be introduced below, but it is sufficient here to note that Feature 6 (2D length) was considered a significant feature for classifying vehicles, pedestrians, cyclists and wheelchairs.

Feature 6 (2D length) is calculated based on the dimension of the generated bounding box that covers the projection of clusters on XY plane, but it cannot stably reflect the true dimension of detected objects. This is because the number of data points collected by roadside LiDAR sensors is affected by factors such as occlusion issues, the sensors' field of view, the relative position and height of the LiDAR sensors and target objects, and the like considerations. In addition, the direction of movement of a road user relative to the scanning direction of the laser beams of the LiDAR sensor also affects the detection quality. In particular, more data points will be collected for an object moving perpendicular to the LiDAR sensor than from objects moving parallel to the LiDAR sensor, and more data points means a more comprehensive description can be obtained for objects. In other words, if LiDAR sensors can scan the side of an object, the detected length value is closer to the real size of the object. However, if LiDAR sensors can only scan the front or back of an object, the reliability of the detected length is low.

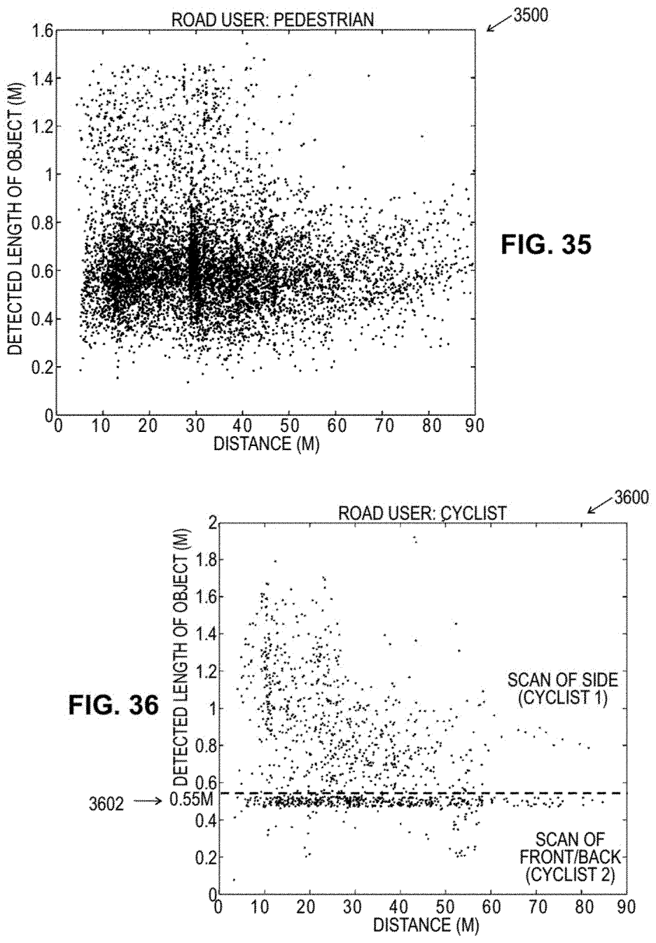

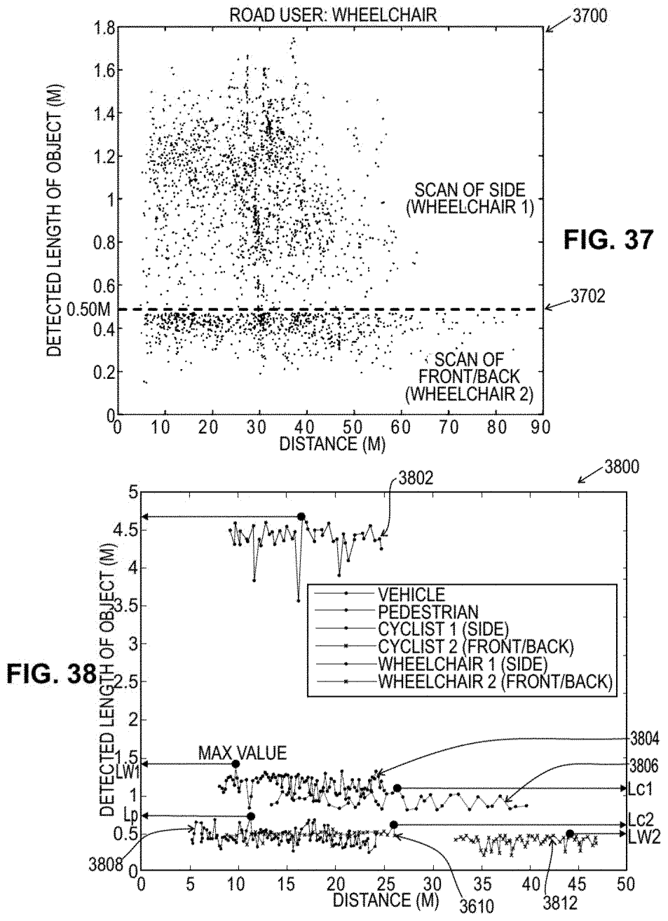

A detailed analysis of FIG. 33 reveals that the direction of movement of cyclists and wheelchairs relative to the LiDAR sensor has a more significant impact on the reliability of the detected length values than for pedestrians. FIG. 35 is a graphical representation 3500 of the distance and length of pedestrian features, whereas FIG. 36 is a graphical representation 3600 of distance and length of cyclist features, and FIG. 37 is a graphical representation 3700 of distance and length of wheelchair features.

In FIG. 36, an imaginary dividing line 3602 can be proposed at approximately the length=0.55 m to distinguish between whether a cyclist is scanned from the side or from the front or back portion. A similar dividing line 3702 can be proposed for wheelchairs in FIG. 37, but it is not obvious if such a dividing line can be proposed for the graphical representation 3500 of the distance and length of pedestrian features shown in FIG. 35. The reason could be that the size of pedestrians is smaller than that for cyclists and that of wheelchairs, so there is not much difference when the side or front/back part of pedestrians is scanned, especially at a far distance away from the LiDAR sensor.

Another characteristic of the Distance-Length distribution is that, for each individual road user, the detected length of the object will fluctuate as the object moves. This characteristic indicates that when an object is moving relative to the LiDAR sensor, the detected dimension (e.g., length) of the same object is also changing and there may be some outliers.

FIG. 38 is a chart 3800 of the detected length of an object as a function of the distance away from a LiDAR sensor. In general, the detected length of a vehicle 3802 is largest, followed by the detected lengths of wheelchairs 3804, cyclists 3806, and pedestrians 3808. Note that cyclist1 3806 was scanned from the side, but that cyclist2 3810 was scanned from the front and/or back and thus the length detected of cyclist1 3806 was generally longer than that of cyclist2 3610. Similarly, the length detected of wheelchair1(side) 3804 was longer than that for wheelchair2 (front/back) 3812. Thus, in some embodiments, during the feature extraction step (Feature 6—the 2D length) each sample in both the training set and the testing set was updated to the maximum value of all detected lengths within the corresponding trajectory, so as to update signification features.

### Classification Methods

Four supervised classification methods were utilized: artificial neural network (ANN), random forest (RF), adaptive boosting (AdaBoost), and random undersampling boosting (RUSBoost) for vehicle/pedestrian/cyclist/wheelchair classification. A brief description of each is provided below.

Artificial Neural Network (ANN)

ANN is a multilayer feedforward neural network composed of an input layer, a hidden layer, an output layer, and neurons in each layer. Input data are fed into the input layer. The activity of each hidden layer is determined by the inputs and the weights that connect the input layer and hidden layer. A similar process takes place between the hidden layer and the output layer, and the transmission from one neuron in one layer to another neuron in the next layer is independent. The output layer produces the estimated outcomes. The comparison information (error) between the target outputs and the estimated outputs is given back to the input layer as a guidance to adjust the weights in the next training round. Through each iteration, the neural network gradually learns the inner relationship between the input and the output by adjusting the weights for each neuron in each layer to result in a best accuracy output. When the minimum error is reached, or the number of iterations is beyond a predefined range, the training process is terminated with fixed weights.

Random Forest (RF)

Random forest is an ensemble learning method for classification, regression, and other tasks that operates by constructing a multitude of decision trees at training time. For classification tasks, each individual decision tree in the random forest outputs a class prediction and the class with the most votes become the output of the random forest. Random forest essentially enables a large number of weak or weakly-correlated classifiers to form a strong classifier, and generally outperforms decision trees, but its accuracy is lower than that of gradient boosted trees. In addition, the computational cost of running random forest on large datasets is low.

Adaptive Boosting (AdaBoost)

AdaBoost is an ensemble learning method which was initially created to increase the efficiency of binary classifiers. AdaBoost uses an iterative approach to learn from the mistakes of weak classifiers, increase weights for misclassified observations and reduce the weights for correctly classified observations, and turn weak classifiers into strong ones. In terms of AdaBoost for multiclass classification, instead of weighted classification error, weighted pseudo-loss is used as a measure of the classification accuracy from any learner in an ensemble. AdaBoost is fast, simple, and easy to implement and has the flexibility to be combined with other machine learning algorithms, but it is sensitive to noisy data and outliers.

Random Undersampling Boosting (RUSBoost)

Random undersampling boosting is especially effective at classifying imbalanced data, meaning some classes in the training data have much fewer members than others. The algorithm takes N observations in the class with the fewest observations in the training data, as the basic unit for sampling. Classes with more observations are under sampled by taking only N observations of every class. In other words, if there are K classes, for each weak learner in the ensemble, RUSBoost takes a subset of the data with N observations from each of the K classes. The boosting procedure follows the procedure in AdaBoost for multiclass classification for reweighting and constructing the ensemble.

Road User-Data Example

In order to collect road user data, two “Ultra Puck” LiDAR sensors manufactured by the Velodyne company, each having a 10 Hertz (Hz) frequency of rotation, were installed at two intersections (Site 1 and Site 2). At Site 1, roadside LiDAR sensor data of vehicles, pedestrians, and cyclists was collected by portable roadside LiDAR equipment for three days from 7:00 am to 8:00 pm each day. At Site 2, roadside LiDAR sensor data of vehicles, pedestrians, cyclists, and wheelchairs was collected for a two day period and then for a five day period several months later. A “senior center” and a Walmart were located on the opposite side of a selected intersection, and thus some wheelchair activity data was collected within a certain period of time at Site 2.

Due to the characteristic of traffic at the selected intersections of Site 1 and Site 2, the number of vehicles detected was much larger than the number of objects in the other three classes. In order to include more observations of cyclists and wheelchairs in the training and testing datasets, data was selected during certain time periods from Site 2 after watching a raw LiDAR sensor data stream. Since the trajectory information of road users will be used to increase the classification accuracy in an offline manner, the length of continuous trajectories should meet certain standards (e.g., greater than 20 data frames, 0.1 second/frame). To train a classifier, the whole dataset including four categories was divided into Training dataset (70%) and Testing dataset (30%), as shown in Table 5.1 below. It is obvious that compared with vehicles and pedestrians, the number of cyclists and wheelchairs is much smaller, which makes classification with imbalanced datasets challenging.

TABLE 5.1
Training and testing datasets.

| Type | Sample Count |
|---|---|
| Vehicle | 9598 (Site 1: 4896 + |
| | Site 2: 4702) |
| Pedestrian | 8903 (Site 1: 4398 + |
| | Site 2: 4505) |
| Cyclist | 1251 (Site 1: 650 + |
| | Site 2: 601) |
| Wheelchair | 2426 (Site 1: N/A + |
| | Site 2: 2426) |
| Total | 22178 |
| Training dataset (70%) | 15525 |
| Testing dataset (30%) | 6653 |

Note:
Require trajectory length >20 frames (2.0 seconds).

Classification Without Considering Prior Trajectory Information

In this section, seven features (introduced above 3) extracted from the training dataset were inputs of the four selected classifiers (ANN, RF, AdaBoost, and RUSBoost), and then the testing dataset was used to evaluate the performance of the trained classifiers. To measure the quality of classifiers, the recall of each class using different classifiers was calculated. Mathematically, the recall is defined as follows:

$$Recall = \frac{TP}{TP + FN} \qquad ( 1 )$$

where, TP is true positive; FN is false negative.

According to Table 5.2(a) below, the vehicle's recall and pedestrian's recall reached 99% and 97% using ANN, RF, and AdaBoost classifiers, but the cyclist's recall was below 50%. Through dealing with imbalanced data, the RUSBoost classifier can improve the cyclist's recall to 66% but it also reduces the pedestrian's recall to 91%.

TABLE 5.2(a)
Classification recall rates without considering
historical trajectory information.

| Trajectory | | Vehicle | Pedestrian | Cyclist | Wheelchair |
|---|---|---|---|---|---|
| Length | Classifier | Recall | Recall | Recall | Recall |
| Greater than | ANN | 99.55% | 97.51% | 23.58% | 73.69% |
| 20 frames | RF | 99.86% | 98.00% | 40.16% | 81.19% |
| (2.0 s) | AdaBoost | 99.76% | 97.40% | 47.67% | 82.18% |
| | RUSBoost | 99.79% | 91.56% | 66.06% | 82.32% |

Classification Considering Prior Trajectory Information

Taking the modified significant features as input, the recalls of four types of road users using the same classification methods are listed in Table 5.2(b) below. Table 5.2(b) shows that the recall rates of cyclist and wheelchair were all above 99% when using AdaBoost and RUSBoost classifiers, which was a huge improvement compared with the previous results in Table 5.2(a). This indicated the effectiveness of updating significant features by considering prior trajectory information to increase classification accuracy.

TABLE 5.2(b)
Classification recall rates considering
historical trajectory information.

| Trajectory | | Vehicle | Pedestrian | Cyclist | Wheelchair |
|---|---|---|---|---|---|
| Length | Classifier | Recall | Recall | Recall | Recall |
| Greater | ANN | 99.79% | 97.89% | 44.56% | 74.96% |
| than 20 | | (+0.24%) | (+0.38%) | (+20.98%) | (+1.27%) |
| frames | RF | 100% | 99.85% | 94.82% | 98.02% |
| (2.0 s) | | (+0.14%) | (+1.85%) | (+54.66%) | (+16.83%) |
| | AdaBoost | 100% | 99.96% | 100% | 99.86% |
| | | (+0.24%) | (+2.56%) | (+52.33%) | (+17.68%) |
| | RUSBoost | 100% | 100% | 99.74% | 99.43% |
| | | (+0.21%) | (+8.44%) | (+33.68%) | (+17.11%) |

Note:
The value in the parentheses represents the increased recall value compared to Table 3(a).

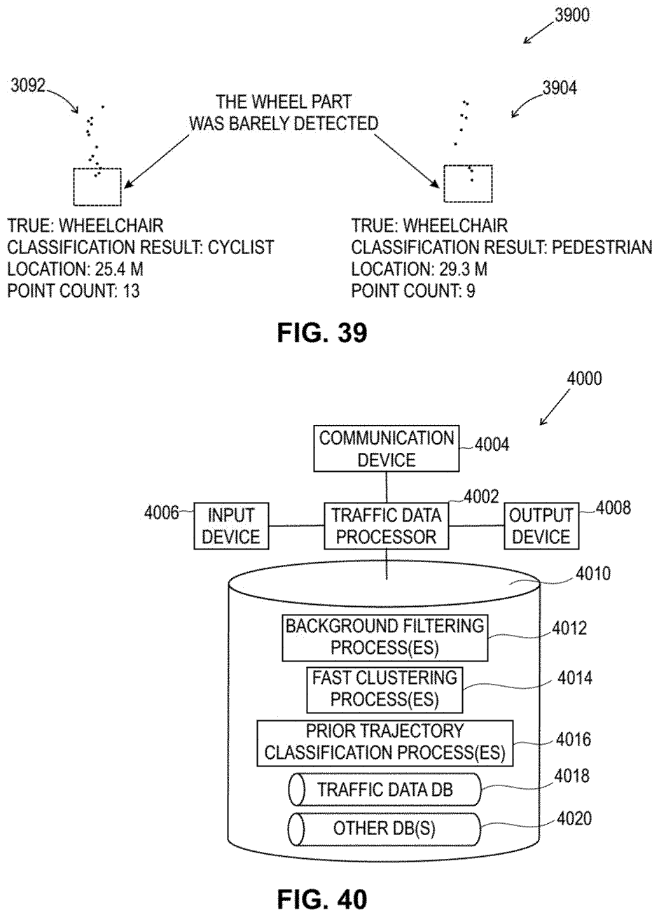

FIG. 39 is a visualization 3900 illustrating the misclassifying of one object for another. Specifically, visualization 3902 shows that, from sensor data collected (13 data points) a wheelchair was incorrectly classified as a cyclist, whereas visualization 3904 shows that, from sensor collected (9 data points) a wheelchair was incorrectly classified as a pedestrian. As illustrated, the wheel portion of the wheelchair cluster was not fully detected, and thus the result was that the main shape and/or dimensional differences between a wheelchair and a cyclist and/or a pedestrian was not obvious. Through checking the raw LiDAR data stream, the entire movement routes of the two wheelchairs were not well covered by the detection range of the LiDAR sensor. This may be the main reason for the misclassification of these wheelchairs, especially at a distance far away from the LiDAR sensor.

Sensitivity Analysis

As a result of the misclassification example explained above in Section 5.2, it was determined that the length of trajectories must be greater than 20 frames, and Feature 6 was updated to the maximum length within the entire trajectory of each object. In this regard, the question of how the trajectory length affects the classification accuracy is discussed herein.

Trajectories longer than 10 data frames and 30 data frames, respectively, were selected and the process of feature selection and classifier's training and testing were repeated. The recall rates of vehicle, pedestrian, cyclist, and wheelchair classification with and without considering historical trajectory are listed below in Table 5.3.

TABLE 5.3
Classification recall rates with different trajectory lengths.

| Trajectory | | Vehicle | Pedestrian | Cyclist | Wheelchair |
|---|---|---|---|---|---|
| Length | Classifier | Recall | Recall | Recall | Recall |
| Greater | ANN | 99.66%/99.79% | 97.33%/97.60% | 20.26%/37.69% | 73.18%/74.86% |
| than 10 | | (+0.13%) | (+0.27%) | (+17.43%) | (+1.68%) |
| frames | RF | 99.90%/100% | 97.97%/99.81% | 40.00%/93.33% | 80.87%/97.91% |
| (2.0 s) | | (+0.10%) | (+1.84%) | (+53.33%) | (+17.04%) |
| | AdaBoost | 99.83%/100% | 97.26%/99.85% | 45.90%/99.49% | 81.28%/99.86% |
| | | (+0.17%) | (+2.59%) | (+53.59%) | (+18.58%) |
| | RUSBoost | 99.90%/100% | 90.27%/99.81% | 64.87%/99.49% | 81.15%/99.86% |
| | | (+0.10%) | (+9.54%) | (+34.62%) | (+18.71%) |
| Greater | ANN | 99.69%/99.76% | 97.53%/98.29% | 19.19%/49.19% | 73.09%/76.98% |
| than 30 | | (+0.07%) | (+0.76%) | (+30.00%) | (+3.89%) |
| frames | RF | 99.86%/100% | 97.91%/99.92% | 41.35%/97.03% | 81.02%/98.80% |
| (3.0 s) | | (+0.14%) | (+2.01%) | (+55.68%) | (+17.78%) |
| | AdaBoost | 99.86%/100% | 98.22%/100% | 44.59%/100% | 82.06%/100% |
| | | (+0.14%) | (+1.78%) | (+55.41%) | (+17.94%) |
| | RUSBoost | 99.86%/100% | 91.53%/100% | 65.41%/100% | 82.81%/100% |
| | | (+0.14%) | (+8.47%) | (+34.59%) | (+17.19%) |

Note:
A/B (C) where A is the recall rate without considering historical trajectory information; B is the recall rate considering historical trajectoiy information; C represents the increase in recall value from A to B.

Comparing the recall rates obtained from trajectories of different lengths in Table 5.2(b) and Table 5.3, the conclusions can be summarized as follows:
1) Generally speaking, longer continuous trajectories can help to improve the classification recall rate. It means that if prior trajectory information is used in feature extraction, the quality of continuous tracking does have an impact on classification accuracy. For example, when the trajectory length is greater than 30 frames, the recall rates of vehicle, pedestrian, cyclist, and wheelchair using AdaBoost and RUSBoost classifiers can achieve 100%.
2) Among ANN, RF, AdaBoost and RUSBoost classifiers, AdaBoost and RUSBoost are better at classifying imbalanced data than RF and ANN.
3) Considering prior trajectory information is an effective way to improve classification accuracy.

Thus, disclosed herein is a feature-based classification method which has been combined with prior trajectory information to beneficially improve the classification of a vehicle, pedestrian, cyclist, and wheelchair using roadside LiDAR sensor data. In some embodiments, six features including distance, point count, direction, height, height variance, 2D length and 2D area extracted from road user clusters were utilized along with four classification algorithms including ANN, RF, AdaBoost and RUSBoost. The updating of critical features based on prior information of the entire trajectory advantageously improved the classification accuracy. The accuracy of using four classifiers to distinguish four types of road users before and after integration with prior trajectory information has been illustrated herein, with example results showing that training AdaBoost and RUSBoost classifiers with prior trajectory information can achieve recall rates for vehicles of 100%, for pedestrians of 99.96%, for cyclists of 99.74%, and for wheelchairs of 99.43% using 32-laser roadside LiDAR sensor data. The trained classifiers can also be used at different sites, which is highly advantageous, and the high classification accuracy of the disclosed methods lays a solid foundation for processing roadside LiDAR sensor data, especially because an advantage of roadside LiDAR is that it can record a large number of historical trajectories of all road users at a fixed location.

FIG. 40 is a block diagram of a traffic data processing computer 4000 according to an embodiment. The traffic data processing computer 4000 may be controlled by software to cause it to operate in accordance with aspects of the methods presented herein concerning processing traffic data generated by one or more roadside LiDAR sensors. In particular, the traffic data processing computer 4000 may include a traffic data processor 4002 operatively coupled to a communication device 4004, an input device 4006, an output device 4008, and a storage device 4010. However, it should be understood that, in some embodiments the traffic data processing computer 4000 may include several computers or a plurality of server computers that work together as part of a system to facilitate processing of traffic data generated by a roadside LiDAR sensor or roadside LiDAR sensor system. In such a system, different portions of the overall method for facilitating traffic data processing of raw LiDAR sensor data may be provided by one or more computers in communication with one or more other computers such that an appropriate scaling up of computer availability may be provided if and/or when greater workloads, for example a large amount of raw traffic data from one or more LiDAR sensors, is encountered.

The traffic data processing computer 4000 may constitute one or more processors, which may be special-purpose processor(s), that operate to execute processor-executable steps contained in non-transitory program instructions described herein, such that the traffic data processing computer 4000 provides desired functionality.

Communication device 4004 may be used to facilitate communication with, for example, electronic devices such as roadside LiDAR sensors, traffic lights, transmitters and/or remote server computers and the like devices. The communication device 4004 may, for example, have capabilities for engaging in data communication (such as traffic data communications) over the Internet, over different types of computer-to-computer data networks, and/or may have wireless communications capability. Any such data communication may be in digital form and/or in analog form.

Input device 4006 may comprise one or more of any type of peripheral device typically used to input data into a computer. For example, the input device 4006 may include a keyboard, a computer mouse and/or a touchpad or touchscreen. Output device 4008 may comprise, for example, a display screen (which may be a touchscreen) and/or a printer and the like.

Storage device 4010 may include any appropriate information storage device, storage component, and/or non-transitory computer-readable medium, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium.”

The term “computer-readable medium” as used herein refers to any non-transitory storage medium that participates in providing data (for example, computer executable instructions or processor executable instructions) that may be read by a computer, a processor or a like device. Such a medium may take many forms, including but not limited to, non-volatile media and volatile media. Non-volatile media may include, for example, optical or magnetic disks and other persistent memory. Volatile media may include dynamic random access memory (DRAM), which typically constitutes the main memory. Common forms of computer-readable media include, for example, a floppy disk, a flexible disk, hard disk, magnetic tape, a solid state drive (SSD), any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in providing sequences of computer processor-executable instructions to a processor. For example, sequences of instruction (i) may be delivered from RAM to a processor, (ii) may be wirelessly transmitted, and/or (iii) may be formatted according to numerous formats, standards or protocols, such as Transmission Control Protocol, Internet Protocol (TCP/IP), Wi-Fi, Bluetooth, TDMA, CDMA, and 3G.

Referring again to FIG. 40, storage device 4010 stores one or more programs for controlling the processor 4002. The programs comprise program instructions that contain processor-executable process steps of the traffic data processing computer 4000, including, in some cases, process steps that constitute processes provided in accordance with principles of the processes disclosed herein. In some embodiments, such programs include, for example, background filtering process(es) 4012, fast clustering process(es) 4014 and prior trajectory process(es) 4016 to process traffic data received from one or more roadside LiDAR sensors.

The storage device 4010 may also include one or more traffic data database(s) 4018 which may store, for example, prior traffic trajectory data and the like, and which may also include computer executable instructions for controlling the traffic data processing computer 4000 to process sensor data and/or information to make the classification of roadside users possible in a manner that can be transmitted to connected vehicles and/or for further study of road use by users such as vehicles, cyclists, pedestrians and wheelchair users. The storage device 4010 may also include one or more other database(s) 4020 and/or have connectivity to other databases (not shown) which may be required for operating the traffic data processing computer 4000.

Application programs and/or computer readable instructions run by the traffic data processing computer 4000, as described above, may be combined in some embodiments, as convenient, into one, two or more application programs. Moreover, the storage device 4010 may store other programs or applications, such as one or more operating systems, device drivers, database management software, web hosting software, and the like.

As used herein, the term “computer” should be understood to encompass a single computer or two or more computers in communication with each other.

As used herein, the term “processor” should be understood to encompass a single processor or two or more processors in communication with each other.

As used herein, the term “memory” should be understood to encompass a single memory or storage device or two or more memories or storage devices.

As used herein, a “server” includes a computer device or system that responds to numerous requests for service from other devices.

The above descriptions and illustrations of processes herein should not be considered to imply a fixed order for performing the process steps. Rather, the process steps may be performed in any order that is practicable, including simultaneous performance of at least some steps and/or omission of steps.

Although the present disclosure has been described in connection with specific example embodiments, it should be understood that various changes, substitutions, and alterations apparent to those skilled in the art can be made to the disclosed embodiments without departing from the spirit and scope of the disclosure.

What is claimed is:

1. A method for conducting background filtering on roadside LiDAR sensor data comprising:
receiving, by a computer processor of a computer from a roadside LiDAR sensor, raw LiDAR sensor data;
decoding, by the computer processor, the raw LiDAR sensor data into 3D distance data, azimuth angle data and vertical angle data;
generating, by the computer processor, a background table of datapoints utilizing the azimuth angle data and elevation data;
comparing, by the computer processor, the 3D distance data to the datapoints comprising the background table;
determining, by the computer processor based on the comparisons, static background object datapoints; and
discarding, by the computer processor, the static background object datapoints.

2. The method of claim 1, further comprising:
determining, by the computer processor based on the comparisons, dynamic background object datapoints; and
discarding, by the computer processor, the dynamic background object datapoints.

3. The method of claim 1, further comprising:
determining, by the computer processor based on the comparisons, target datapoints; and
storing, by the computer processor in a storage device, the target datapoints.

4. A traffic data processing computer for conducting background filtering on LiDAR sensor data comprising:
a traffic data processor;
a communication device operably connected to the traffic data processor; and
a storage device operably connected to the traffic data processor, wherein the storage device stores processor executable instructions which when executed cause the traffic data processor to:
receive raw LiDAR sensor data from a roadside LiDAR sensor;
decode the raw LiDAR sensor data into 3D distance data, azimuth angle data and vertical angle data;
generate a background table of datapoints utilizing the azimuth angle data and elevation data;
compare the 3D distance data to the datapoints comprising the background table;
determine static background object datapoints based on the comparisons; and
discard the static background object datapoints.

5. The apparatus of claim 4, wherein the storage device stores further processor executable instructions which when executed cause the traffic data processor to:
determine dynamic background object datapoints based on the comparisons; and
discard the dynamic background object datapoints.

6. The apparatus of claim 4, wherein the storage device stores further processor executable instructions which when executed cause the traffic data processor to:
determine target datapoints based on the comparisons; and
store the target datapoints in a storage device.

7. A method for generating a final background datapoint table utilizing LiDAR sensor data comprising:
receiving, by a computer processor of a computer from a roadside LiDAR sensor, raw LiDAR sensor data;
decoding, by the computer processor, the raw LiDAR sensor data into three-dimensional (3D) point cloud location data;
aggregating and saving, by the computer processor in a storage device, distance values obtained from the 3D point cloud location data in a two-dimensional structure format;
obtaining, by the computer processor, datapoint values comprising values that are the farthest from the LiDAR sensor by segmenting and sorting the distance values;
determining, by the computer processor, that the datapoint values satisfy a point threshold; and
classifying, by the computer processor, the datapoint values as static background datapoint values; and
storing, by the computer processor into an initial background table of a storage device, the static background datapoint values for use in filtering decoded LiDAR sensor data to generate a 3D LiDAR sensor point cloud that excludes static background objects.

8. The method of claim 7, further comprising extracting, by the computer processor, undesirable features using a clustering process.

9. The method of claim 7, further comprising:
generating, by the computer processor, target datapoints by utilizing a dynamic background classifier; and
generating, by the computer processor, dynamic background object datapoints.

10. The method of claim 9, further comprising storing, by the computer processor in the storage device, the target datapoints.

11. The method of claim 9, further comprising:
generating, by the computer processor, a final background table by updating the initial background table; and
storing, by the computer processor, the final background table in the storage device.

12. A fast spherical projection based clustering method for processing LiDAR sensor data comprising:
receiving, by a computer processor of a computer from a roadside LiDAR sensor, raw LiDAR sensor data;
decoding, by the computer processor, the raw LiDAR sensor data into a three-dimensional (3D) point cloud of datapoints;
converting, by the computer processor, the 3D point cloud of datapoints using spherical projection into a two-dimensional (2D) map by projecting a distance value of each datapoint onto a 2D map according to corresponding spherical information comprising azimuth data and zenith data;
searching, by the computer processor, neighborhoods on the 2D map;
generating, by the computer processor, object clustering labels indicating whether a point is associated with a specific object; and
generating, by the computer processor based on the object clustering labels, a 2D labeling map wherein each cell stores a point-wise instance label.

13. A traffic data processing computer for processing LiDAR sensor data comprising:
a traffic data processor;
a communication device operably connected to the traffic data processor; and
a storage device operably connected to the traffic data processor, wherein the storage device stores processor executable instructions for a fast spherical projection based clustering method which when executed cause the traffic data processor to:
receive raw LiDAR sensor data from a roadside LiDAR sensor;
decode the raw LiDAR sensor data into a three-dimensional (3D) point cloud of datapoints;
convert the 3D point cloud of datapoints using spherical projection into a two-dimensional (2D) map by projecting a distance value of each datapoint onto a 2D map according to corresponding spherical information comprising azimuth data and zenith data;
search neighborhoods on the 2D map;
generate object clustering labels indicating whether a point is associated with a specific object; and
generate a 2D labeling map based on the object clustering labels, wherein each cell stores a point-wise instance label.

14. A feature-based road user classification method for LiDAR sensor systems comprising:
receiving, by a computer processor of a computer from a roadside LiDAR sensor, a stream of raw LiDAR sensor data; and
generating, by the computer processor, high-resolution all-traffic trajectory data of all road users by conducting a background filtering step, an object clustering step, an object classification step and an object tracking step on the raw LiDAR sensor data.

15. The method of claim 14, further comprising:
generating, by the computer processor for a predetermined time period, geo-located trajectory data based on the high-resolution all-traffic trajectory data; and
displaying, by the computer processor on a display device, a visualization of the geo-located trajectory data of all road users.

16. The method of claim 14, wherein generating high-resolution all-traffic trajectory data further comprises integrating, by the computer processor, historical trajectory information into the object classification step to improve classification accuracy.

17. The method of claim 15, wherein the high-resolution all-traffic trajectory data is associated with road users comprising at least one of vehicles, pedestrians, cyclists, and wheelchairs.

18. A traffic data processing computer for classifying road users comprising:
a traffic data processor;
a communication device operably connected to the traffic data processor; and
a storage device operably connected to the traffic data processor, wherein the storage device stores processor executable instructions which when executed cause the traffic data processor to:
receive a stream of raw LiDAR sensor data from a roadside LiDAR sensor; and
generate high-resolution all-traffic trajectory data of all road users by conducting a background filtering step, an object clustering step, an object classification step and an object tracking step on the raw LiDAR sensor data.

19. The apparatus of claim 18, wherein the storage device stores further processor executable instructions which when executed cause the traffic data processor to:
generate geo-located trajectory data based on the high-resolution all-traffic trajectory data for a predetermined time period; and
display a visualization of the geo-located trajectory data of all road users on a display device.

20. The apparatus of claim 18, wherein the instructions for generating high-resolution all-traffic trajectory comprises instructions, stored in the storage device, which when executed cause the traffic data processor to integrate historical trajectory information into the object classification step to improve classification accuracy.
